(19) United States
(12) Patent Application Publication
(10) Pub. No.: US 2002/0184121 A1
(43) Pub. Date: Dec. 5, 2002

(54) Methods and system for performing business-to-business electronic invoice presentment and payment with line item level granularity

(75) Inventors: Michael Anthony Sijacic, San Francisco, CA (US); Michal Chmielewski, San Jose, CA (US); Blake Groves, Palo Alto, CA (US); Praveena Varadarajan, Sunnyvale, CA (US); Ryan Nguyen, Milpitas, CA (US); Shailendra Goel, Palo Alto, CA (US)

Correspondence Address: FINNEGAN, HENDERSON, FARABOW, GARRETT &, DUNNER LLP, 1300 I STREET, NW, WASHINGTON, DC, 20006, US

(73) Assignee: Sun Microsystems, Inc.

(21) Appl. No.: 09/867,651

(22) Filed: May 31, 2001

(51) Int. Cl. G06F 17/60

(52) U.S. Cl. 705/30

(57) ABSTRACT

A system and method for performing Electronic Invoice Presentment and Payment (EIPP) processing at a line item granularity is disclosed. A server enables a purchasing entity to designate approvers for selected departments within the purchasing entity. The server receives from a providing entity invoices that each include one or more line items. The server processes the invoices and stores line item data associated with each line item in a database. Using the line items included in the invoices, the server determines departments that each line item is associated with and whether each department has a designated approver. In response to a notification message from the server, an approver may request access to invoice information associated with their department. The server accesses the database and makes available only information associated with line items included in the invoices that are associated with the approver's corresponding department.

### CROSS-REFERENCE TO RELATED APPLICATIONS

This application relates to applications, Attorney Docket Nos. 06502.0340.00000, entitled “METHODS AND SYSTEM FOR PERFORMING ELECTRONIC INVOICE PRESENTMENT AND PAYMENT DISPUTE HANDLING WITH LINE ITEM LEVEL GRANULARITY,” 06502.0338.00000, entitled “METHODS AND SYSTEM FOR DEFINING AND CREATING CUSTOM ACTIVITIES WITHIN PROCESS MANAGEMENT SOFTWARE,” and 06502.0339.00000, entitled “METHODS AND SYSTEM FOR INTEGRATING XML BASED TRANSACTIONS IN AN ELECTRONIC INVOICE PRESENTMENT AND PAYMENT ENVIRONMENT,” filed concurrently with the present application, owned by the assignee of this application and expressly incorporated herein by reference in their entirety.

### DESCRIPTION OF THE INVENTION

1. Field of the Invention

This invention relates to electronic invoice presentment and payment systems and, more particularly, to methods, systems and articles of manufacture for performing business-to-business invoice presentations at a line item level of granularity

2. Background of the Invention

Businesses charge for goods and/or services that they provide and customers who receive these goods and/or services pay for them. Although the cost of providing these goods and/or services are typically associated with a business' operating costs, the transaction costs associated with managing billing operations are sometimes overlooked.

Currently, businesses spend millions of dollars to process account information and bill customers. Billing systems and processes are predominately paper based and are conducted through human interaction. The billing costs associated with paper, handling and postage, not to mention the availability of funds, increases with each new customer a business serves.

Today, to offset the costs of managing its billing operations, businesses have entertained the implementation of Business-to-Customer (B2C) Internet Bill presentment and Payment (IBPP) systems. By implementing an IBPP system, business may allow customers to view, store and pay recurring bills using a Web browser, e-mail, or personal financial management software. Accordingly, the IBPP market is growing in popularity due to its inherent benefit of reducing the costs associated with billing operations.

Based on the success of business-to customer (B2C) based IBPP systems, businesses have contemplated the implementation of IBPP concepts to business-to-business (B2B) markets. Through this foresight, Electronic Invoice Presentment and Payment (EIPP) systems have evolved. The business-to-business (B2B) EIPP market represents a significant departure from the business-to-customer (B2C) IBPP market. As with their counterpart, B2B EIPP systems allow businesses to save money through less paper work. However, in addition to these benefits, B2B EIPP systems also allow businesses to have more control over and insight the entire invoice process, including disputing and recalculating their bills prior to payment.

Conventional B2B EIPP systems allow businesses to have invoices presented, processed and paid through an intermediate service. In doing so, the intermediate service generally downloads an entire invoice from a provider of goods and/or services and enables the invoice to be managed on-line by both the provider and a purchaser. Although such services enable businesses to perform invoice processes electronically, dispute and payment processing is limited to the entire invoice. That is, if the purchaser disputed a particular line item within an invoice, the entire invoice would have to be disputed. Thus, the inherent advantages of using online B2B invoice processing is nullified by forcing the purchaser to contact the provider to clarify the line items that are in dispute. Although current B2B EIPP systems, such as BizCast™ from Avolent and NetTransact™ from Bottomline Technologies®, manage invoices (such as tracking the status of individual line items), these systems do not allow line items to be processed according to a purchaser's specifications.

### SUMMARY OF THE INVENTION

It is therefore desirable to have a method and system that enables line items associated with invoices generated by a providing entity to be managed according to a customized approval management structure associated with a purchasing entity in order to facilitate line item dispute management operations.

Methods, systems and articles of manufacture consistent with the present invention enable a provider to provide information associated with invoices corresponding to one or more purchasers to a server. The invoices may include one or more line items that designate goods and/or services provided by the provider. The line items may designate particular departments within a purchaser that received the goods and/or services.

Additionally, methods, systems and articles of manufacture enable the server to structure the invoice information received by the provider by line items and the departments indicated by the line items. The server may also allow designated approvers, who are authorized to review the decisions of subordinate approvers, to receive not only invoice data associated with their respective departments, but also invoice data (including line items) reviewed by these subordinate approvers. When a designated approver for a particular department of a purchaser requests to review invoice data that have been reviewed by subordinate approvers, the server utilizes an approval hierarchy and stored line item information to present an in-box of invoices directly associated with the designated approver's corresponding department.

Methods, systems and articles of manufacture consistent with the present invention may also enable a designated approver to view individual line items within selected invoices to approve (accept) or reject (dispute) purchases indicated in these individual line items. The server receives the designated approver's decisions associated with particular line items and makes available an indication of the decisions to the provider.

In addition to the above features, methods, systems and articles of manufacture consistent with the present invention enable a purchaser to customize an approval and dispute process based on their business requirements.

Additional advantages of the invention will be set forth in part in the description which follows, and in part will be obvious from the description, or may be learned by practice of the invention. The advantages of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate several embodiments of the invention and together with the description, serve to explain the principles of the invention. In the drawings,

FIG. 1A illustrates an exemplary management structure for a purchasing entity consistent with features and principles of the present invention;

FIG. 1B illustrates an exemplary approver hierarchy consistent with features and principles of the present invention;

FIG. 2A illustrates an exemplary system environment in which features and principles of the present invention may be implemented;

FIGS. 2B, 2C, 2D and 2E illustrate exemplary block diagrams of processes performed by a biller manager process consistent with features and principles of the present invention;

FIG. 3 illustrates an exemplary structural view of multiple systems consistent with features and principles of the present invention;

FIG. 4A illustrates an exemplary flowchart for manager approval processing consistent with features and principles of the present invention;

FIG. 4B illustrates an exemplary flowchart for approver processing consistent with features and principles of the present invention;

FIG. 4C illustrates an exemplary flowchart for delegation approval processing consistent with features and principles of the present invention;

FIG. 4D illustrates an exemplary flowchart for invoice amount approval processing consistent with features and principles of the present invention; and

FIG. 4E illustrates an exemplary flowchart for dispute resolution processing consistent with features and principles of the present invention;

FIG. 5A illustrates an exemplary flowchart for processing an invoice consistent with features and principles of the present invention;

FIG. 5B illustrates an exemplary invoice consistent with features and principles of the present invention;

FIG. 6 illustrates exemplary summary and line item tables consistent with features and principles of the present invention;

FIG. 7 illustrates an exemplary subordinate approver in-box consistent with features and principles of the present invention;

FIG. 8 is an exemplary flowchart for processing a request from a subordinate approver consistent with features and principles of the present invention;

FIG. 9 illustrates an exemplary description of a line item invoice associated with a subordinate approver consistent with features and principles of the present invention;

FIG. 10 illustrates an exemplary flowchart for processing a request from a designated approver consistent with features and principles of the present invention;

FIG. 11 illustrates an exemplary designated approver in-box consistent with features and principles of the present invention;

FIG. 12 illustrates an exemplary description of a line item invoice associated with a designated approver consistent with features and principles of the present invention; and

FIG. 13 illustrates an exemplary flowchart for dispute resolution processing consistent with features and principles of the present invention.

### DETAILED DESCRIPTION

Methods, systems and articles of manufacture consistent with the present invention enable a purchasing entity to perform approval/dispute processing corresponding to invoices generated by a providing entity. An EIPP server facilitates the approval/dispute processing by collecting invoice information from a providing entity and structuring this information for use by the providing entity. The invoice information may be associated with one or more invoices that reflect purchases of goods and/or services by a purchasing entity. Each invoice may include one or more items corresponding to particular goods and/or services provided to a particular sub-entity associated with the purchasing entity. For example, the purchasing entity may be a corporation and the sub-entity may be a department within the corporation.

The purchasing entity may utilize the EIPP server to customize an approval/dispute process associated with these invoices. In one aspect of the invention, the purchasing entity may designate approvers, individuals authorized to review invoice items for each sub-entity. Additionally, a specific approval/dispute process may by defined that allows items that have been reviewed by particular approvers to be made available to other designated approvers for further review.

To allow the items in invoices to be made available for review, methods, systems and articles of manufacture consistent with the present invention enable the EIPP server to generate an in-box similar to the in-box utilized by known electronic mail software applications. The generated in-box provides information corresponding to items associated with a designated approver associated with the purchasing entity who generated a request to review the invoice(s). In one aspect of the invention, the in-box may include items that correspond to a sub-entity (or sub-entities) that the requesting approver is authorized to review, while excluding items that are associated with other sub-entities.

The requesting approver may review the items presented in the in-box, and either approve or dispute each item. The EIPP server collects the approver's decisions and performs approval/dispute processing based on the customized process defined by the purchasing entity. In one aspect of the invention, the customized process may allow the approver's decisions to be made available to another approver who is authorized to review items associated with the sub-entity corresponding to the requesting approver. The EIPP server may generate another in-box associated with the second approver to facilitate additional approval/dispute processing for the items previously reviewed by the first requesting approver.

Methods, systems and articles of manufacture consistent with the present invention may also enable the purchasing entity to define an automatic approval process based on a monetary value of invoices or items within an invoice. Approved items may be made available to payment entities within the purchasing entity to facilitate payment to the providing entity for the goods and/or services associated with the approved items. Disputed items within an invoice, on the other hand, may be processed by a dispute resolution process managed by the EIPP server.

Reference will now be made in detail to the exemplary embodiments of the invention, examples of which are illustrated in the accompanying drawings. Wherever possible, the same reference numbers will be used throughout the drawings to refer to the same or like parts.

In the B2C space, an invoice usually involves a single purchaser of goods and services for a single business entity. In the B2B space, however, complex relationships exist between various departments, divisions, units, and, in the case of large conglomerates, even completely separate businesses. Within single invoices, a purchasing entity needs to be able to assign line items to various entities (individuals, groups, departments, etc.) depending upon its needs. Accordingly, methods and systems consistent with the present invention enable a purchasing entity to define one or more approvers for line items within an invoice that may differ from the purchasing entity's actual management hierarchical structure.

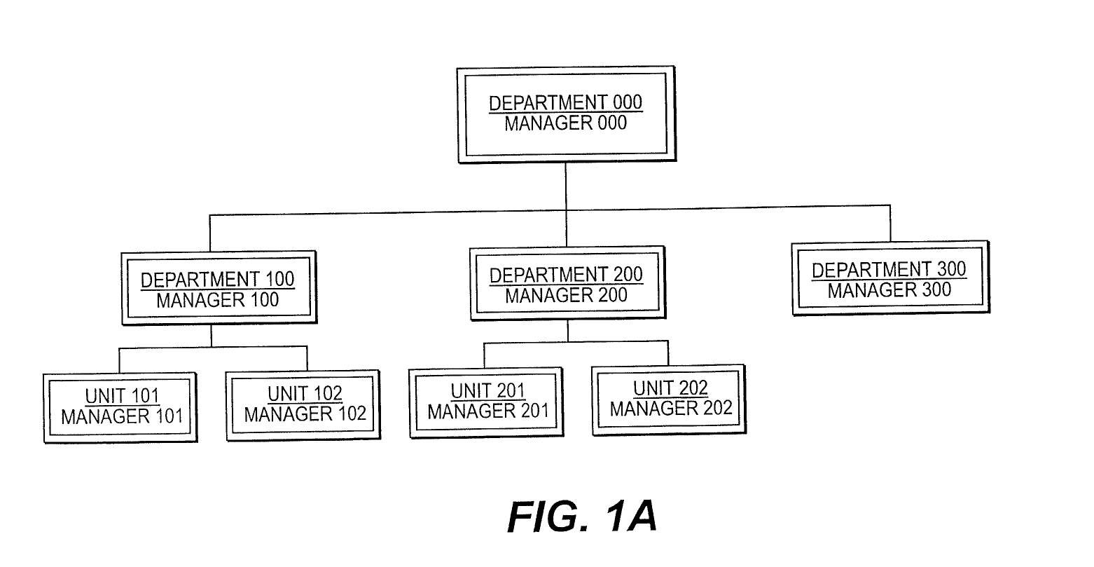

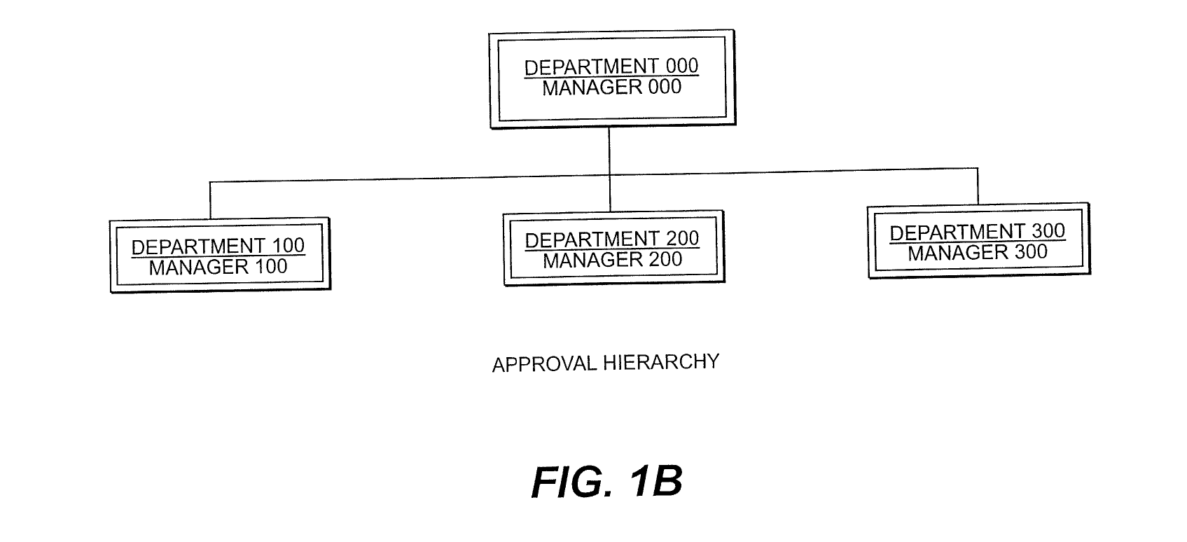

FIG. 1A shows an exemplary portion of a purchasing entity's management hierarchical structure 100. As shown in FIG. 1A, an exemplary purchasing entity called “eCompany” includes a department 000 that is headed by manager 000. In turn, departments 100, 200 and 300 are sub-departments of department 000, and are headed by managers 100, 200 and 300, respectively. Managers 100, 200 and 300 each report to manager 000. Within each sub-department, there may be further separation of individual units. As shown in FIG. 1A, units 101 and 102, headed by managers 101 and 102, respectively, are sub-departments of department 100. Furthermore, units 201 and 202, headed by managers 201 and 202, respectively, are sub-departments of sub-department 200.

The hierarchical structure of a entity, such as the one shown in FIG. 1, can become quite complex, spanning multiple divisions, geographies and departments. The simple hierarchical structure shown in FIG. 1A is exemplary and is not intended to be limiting, but will be used to illustrate the features of the present invention. Furthermore, the term “department” is not intended to define a specific managerial level within a purchasing entity. The term “department” may be associated with any form of segregation of an entity that may include units, divisions, groups, sub-entities, or any other term that may be associated with a entity's structural business model.

FIG. 1B illustrates an exemplary approval hierarchy associated with purchasing entity eCompany. As shown in FIG. 1B, manager 000 is identified as an approver for all decisions made by managers defined below department 000 in the hierarchy. For instance, manager 000 is an approver for decisions made by managers 100, 200 and 300. In turn, each manager 100, 200 and 300 are approvers for decisions made within their respective departments and any underlying departments. Therefore, referring to FIG. 1A, decisions made by managers 101 and 102 are reviewed by manager 100, while decisions by managers 201 and 202 are reviewed by manager 200. As will be described later, a purchasing entity may customize their approval hierarchy in any manner deemed fit for their business.

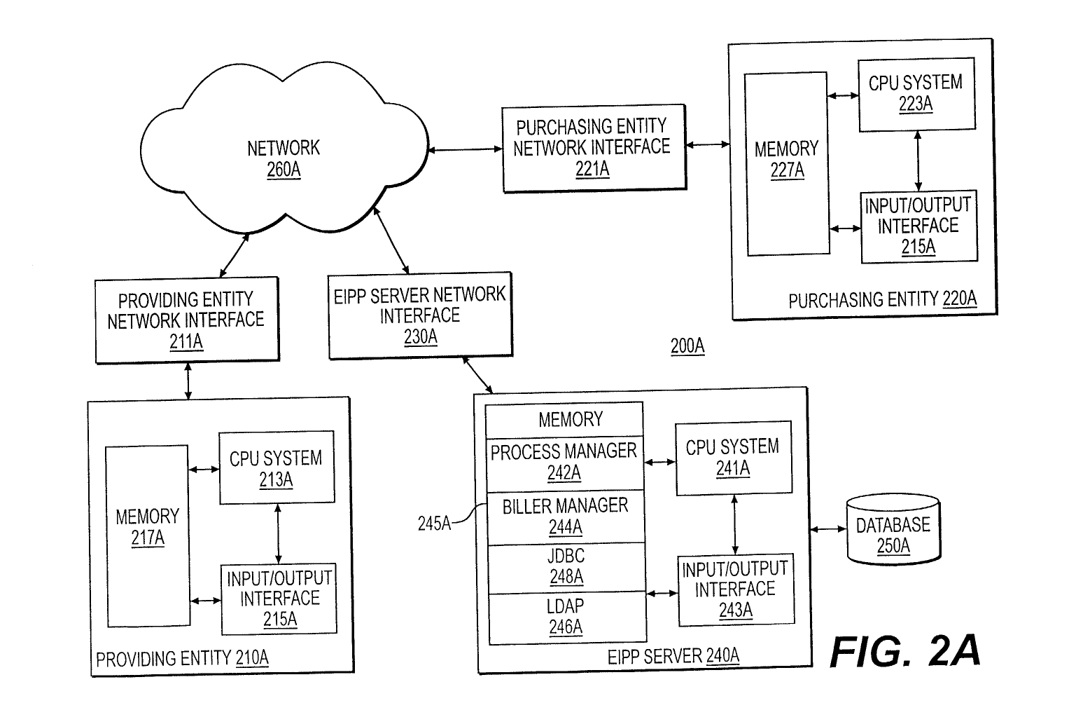

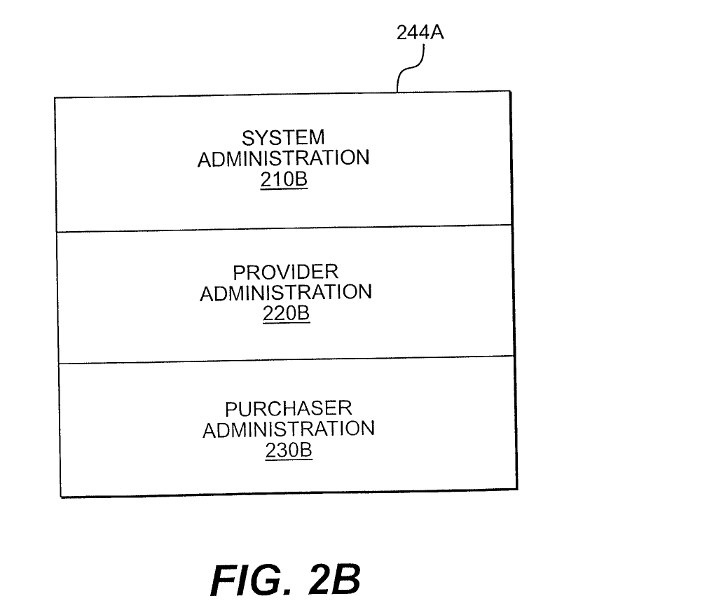

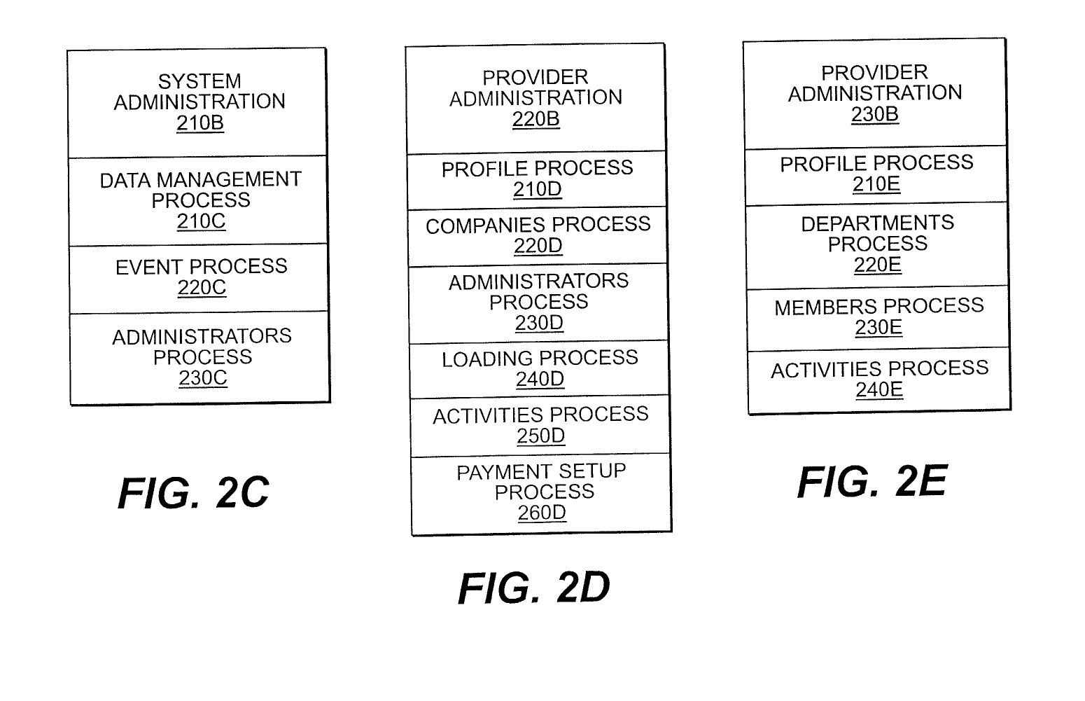

FIG. 2A shows an exemplary system environment 200A in which features and principles consistent with the present invention may be implemented. As shown, system environment 200A includes network 260A, providing entity 210A, purchasing entity 220A, and EIPP server 240A. Also depicted in FIG. 2A are network interfaces 211A, 221A and 230A that may connect their respective entities (and systems) to a network 260A, such as the Internet. Although FIG. 2A shows only one providing entity and purchasing entity, it is understood that any number of purchasing entities may be associated with one or more providing entities that may operate in accordance with the following description of providing entity 210A and purchasing entity 220A. Furthermore, system environment 200A may include a plurality of EIPP servers 240A that collectively perform the B2B EIPP features consistent with the present invention.

Providing and purchasing entities 210A, 220A, and EIPP server 240A, each may be implemented using virtually any type of computer system. For example, as shown in FIG. 2A, providing entity 210A, purchasing entity 220A and EIPP server 240A each may respectively include: a CPU system 213A, 223A, 241A; an associated memory 217A, 227A, 245A; and an input/output interface 215A, 225A and 243A. Providing entity 210A, purchasing entity 220A, and EIPP server 240A may also include a number of other elements and functionalities (not shown) typical in today's computer systems. Providing entity 210A, purchasing entity 220A and EIPP server 240A may each have associated with it an input means such as a keyboard and mouse (not shown). Also, entities 210A and 220A, as well as EIPP server 240A, may also include an output device such as a display, that may generate graphical representations through the use of a browser application executed by their respective CPU systems. These input and output means may take other forms as well without departing from the scope of the invention.

Providing entity 210A may represent a business entity that generates bills for its customers in the form of invoices. Associated with providing entity 210A, may be personnel that handle particular aspects of the billing process. This billing personnel may include, but are not limited to: a system administrator who may administer the system component (such as database controls, etc.); a company administrator who may mange access to the system and may also perform other business functions such as loading invoice data into the system; and dispute handlers who handle disputes from purchasing entities, such as purchasing entity 220A, associated with the invoices generated by providing entity 210A.

Purchasing entity 220A may represent a business that orders goods and/or services from providing entity 210A. Associated with purchasing entity 210A may be personnel that handle particular aspects of a payment process corresponding to invoices produced by providing entity 210A. The payment processing personnel may include, but is not limited to: a company administrator who manages user, company and organization information; approvers who are assigned invoices for approval; and payers who are authorized to pay invoices for purchasing entity 220A. For exemplary purposes, the approvers for purchasing entity 220A may be those depicted in FIG. 1B.

In one aspect of the invention, EIPP server interface 230A may include a web server (not shown) that acts as a proxy for requests that are received from providing and purchasing entities 210A, 220A, respectively, and passes the requests to EIPP server 240A for processing. The web server may also participate in dynamic load balancing operations when system 200A is implemented with multiple EIPP servers. In such an environment, incoming requests are received at the web server and a load balancing system may direct each request to an EIPP server that is determined to be the one best suited to process it. The types of load balancing that may be implemented include, but is not limited to: server load, response time, round robin and weighted round robin mechanisms.

EIPP server 240A performs the B2B EIPP functions in accordance with features and principles of the present invention. As shown in FIG. 2A, the memory 245A contained within EIPP server 240A may include a plurality of processes that are utilized by EIPP server 240A to perform functions consistent with features of the present invention. These processes may include, but are not limited to: a process manager 242A, a biller manager 244A, LDAP process 246A and Java Database Caller JDBC 248A. EIPP server 240A may provide dynamic load balancing (working with the web server) and failure recovery. As previously mentioned, EIPP server 240A may be implemented with a plurality of servers that facilitate fault tolerant operations. In the event one server fails, another server may take over to handle the requests previously processed by the failed server. EIPP server 240A may also implement automatic application restarting and maintain and replicate distributed user-session information and distributed application-state information. In this manner, information may be maintained as long as more than one server installation is running in a cluster with the server that failed.

EIPP server 240A may be configured as a high performance, multi-threaded and multi-processing application server. EIPP server 240A may handle a high number of concurrent requests, database connections, user sessions, and provide optimal performance under heavy loads through the use of: (1) database connection caching that enables EIPP server 240A to cache database connections so that common database connections are reused instead of reestablished; (1) result caching that enables EIPP server 240A to cache the results of application logic so that if the same request is made again, the results in the cache may be used; (3) data streaming that enables the EIPP server 240A to stream back results to the user as the data is returned instead of waiting for the entire response to complete; and (4) multi-threaded capabilities that enable application logic within EIPP server 240A to be processed on multiple threads, thus allowing the application to maximize CPU resources.

Collectively, interface 230A, EIPP server 240A and database 250A may be configured as a Java 2 Platform, Enterprise Edition (J2EE). The J2EE platform comprises of a set of services, application programming interfaces (APIs) and protocols for developing web-based applications. For more information on the J2EE platform, see Steven Gould, Develop N-Tier Applications Using J2EE, An Introduction to Java 2 Platform, Enterprise Edition Specification by Way of BEA's WebLogic Server, JavaWorld, (December 2000) <www.JavaWorld.com/javaworld/jw-12-2000/jw-1201-weblogic_p.ht>.

LDAP process 246A may allow EIPP server 240A to communicate with a configuration LDAP server and a User & Group (U& G) LDAP server (not shown). LDAP servers store data (entries) in a hierarchical manner and include attributes describing information about the entries. Relationships between the entries may be inferred by strategic placement of the entries in the hierarchy. Accordingly, LDAP servers allow efficient retrieval of information through the use of the attributes and the hierarchy. The configuration LDAP server may store information that EIPP server 240A needs for proper operation. This information may include, for example, database configuration information and process manager application definitions. The U & G LDAP server may store information about all of the users and groups defined within EIPP server 240A. It may also store information about purchasing entity's 220A organizations and the people responsible for approving invoices (approvers).

JDBC process 248A interacts with database 250A and EIPP server 240A to facilitate data transactions. Database 250A may store information associated with the invoice information provided by providing entity 210A. Database 250A may house tables including data corresponding to items within one or more invoices generated by providing entity 210A, and departments associated with purchasing entity 220A. Database 250A may also store information that is used by biller manager 244A and process manager 242A to facilitate the approval/dispute processing features consistent with the present invention. Furthermore, database 250A may also store payment information associated with items for each invoice and process state information associated with workflow processes that are executed by EIPP server 240A. Database 250A may be configured as an Oracle database system.

Process manager 242A is a web based workflow process that manages the routing of workflow through a predefined process. Biller manager 244A works with process manager 242A for invoice approval routing, dispute handling, enrollment process and invoice data distribution. Process manager 242A manages data that pertains to the current state of items in a given workflow process. This includes: (1) where an invoice is in an approval process; (2) the identification of a currently assigned approver for particular invoices; (3) the current state of a user enrollment process; and (4) the history of approvals within the processes. Process manager 242A also allows the above-mentioned processes to be modified to better model the requirements of an individual business, in this case purchasing entity 220A. Process manager 242A may also maintain a history database (not shown). The history database may include information that corresponds to each item in every invoice managed by the EIPP server 240A. The history database may be updated each time a change to an invoice or individual item within an invoice is made. Process manager 242A may be configured as a cluster of Enterprise JavaBeans (EJBs) from Sun Microsystems, Inc. of Palo Alto, Calif. Enterprise JavaBeans are reusable software components that may be manipulated visually in a builder tool. The EJBs include interfaces that (1) define how the EJB may be created or destroyed; (2) define methods that may be invoked on a bean; and (3) a bean class that may implement a main business logic. Clients and EIPP server 240A may utilize the EJBs to create and edit workflow processes consistent with features of the present invention.

Biller manager 244A is responsible for managing the data access and data manipulation of the invoice data within system environment 200A. Particularly, biller manager 244A manages access to any and all business data with respect to invoice data. This data includes: (1) invoice summary data; (2) invoice item detail data; (3) item status (currently in dispute, approved, etc.); (4) invoice payment information; (5) payment history; and (6) customer account information. As with process manager 242A, biller manager 244A may also be configured as EJBs.

Both process manager 242A and biller manager 244A use JDBC 248A to access database 250A for data storage and access. JDBCs are APIs that provides platform independent access to databases, such as database 250A. Biller manager 244A and process manager 242A each contain all of the business logic needed for a solution associated with an invoice problem. Process manager 242A and biller manager 244A each access their own particular data. For instance, biller manager 244A may only directly access business data, while process manager 242A may only access process state information. When process manager 242A requires access to the business data, for example to display invoice data, it communicates directly with biller manager 244A to retrieve the required information from database tables stored within database 250A. Process manager 242A may not directly access data that is managed by biller manager 244A, and conversely, biller manager 244A may not access data managed by process manager 242A.

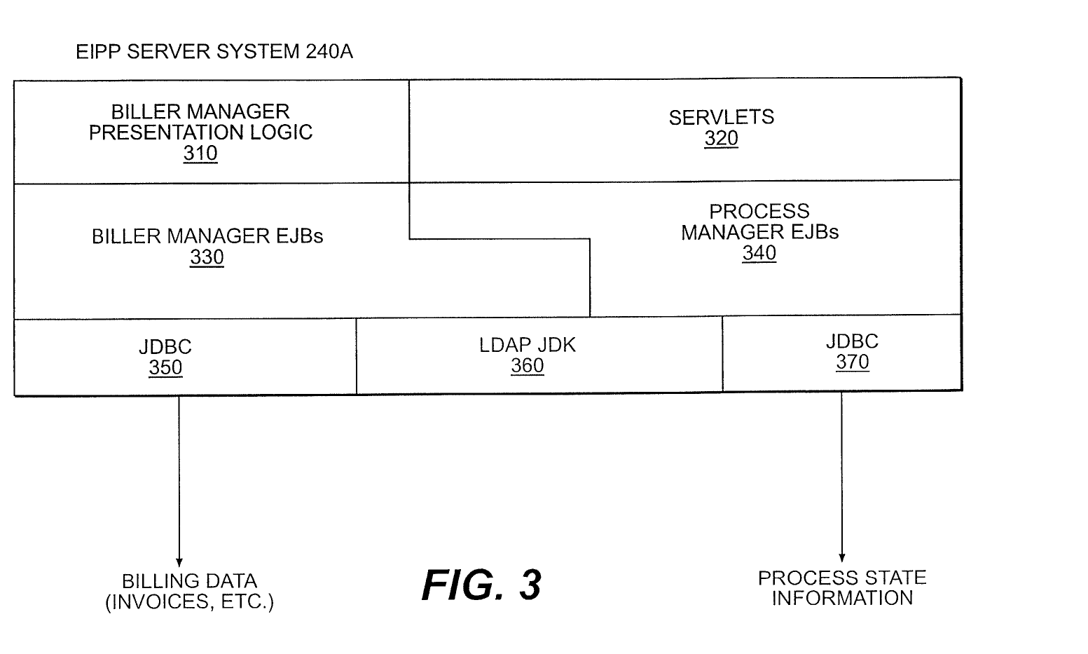

Furthermore, both process manager 242A and biller manager 244A may include front-end presentation logic that is responsible for the communication of EJBs and delivering data populated forms to clients. The presentation logic may be written in the Java™ programming language, and may be configurable using defined templates. EIPP server 240A may be implemented by multiple systems working together. FIG. 3 illustrates an conceptual view of how these systems may fit together. As shown in FIG. 3, the EJBs that make up biller manager 244A and process manager 242A (330 and 340, respectively), reside on the same underlying application server, in this case EIPP server 240A. The biller manager 244A may include presentation logic 310 that enables biller manager 244A to provide the invoice information to requesting entities. Also included in FIG. 3 are servlets 320. Servlets are small Java™ programs that extend the functionality of a server. Similarly to Common Gateway Interfaces (CGIs), servlets 320 may be executed dynamically when requested. Unlike CGIs, however, servlets may be executed as a separate thread, thus offering more scalability in their use than CGIs. FIG. 3 also shows how JDBC processes 350 and 370 interface with the process manager and biller manager EJBs to provide specific types of information. For instance, JDBC 350 interacts with biller manager EJBs 330 to provide billing data, such as invoice information, whereas JDBC 370 interacts with process manager EJBs 340 to provide process state information. Both process manager EJBs 340 and biller manager EJBs 330 may interact with LDAP Java Developer Kit (JDK) process 360 to enable a software development kit (SDK) for enabling clients or entities to produce Java programs. The JDK is developed by Sun Microsystem's JavaSoft division and includes a JavaBeans component architecture and support for JDBC.

Biller manager 244A may facilitate three levels of administration within system environment 200A. FIG. 2B illustrates these three levels of administration processes. As shown in FIG. 2B, Biller manager 244A may facilitate a system administration process 210B, a provider administration process 220B, and a purchaser administration 230B.

System administration process 210B may use a system administration tool to perform system related administration processes, such as data management, events and administrators. FIG. 2C illustrates an exemplary view of system administration 210B including these processes. The data management process 210C may enable an administrator of EIPP server 240A to manually load invoice, user and department data; purge and recover the database of older data; and set an active archive directory where the loaded files are stored. The events process 220C may enable an administrator can create custom events that are triggered within the system at certain times. A graphical setup screen may be provided to allow an administrator to define these events. And administrators process 230C may use the system administration tool to create additional administrators.

Provider administration process 220B may be used by providing entity 210A to setup and administer the business aspects of the B2B EIPP system consistent with features and principles of the present invention. FIG. 2D illustrates an exemplary view of the processes associated with provider administration process 220B. The processes that may be included in provider administration process 220B may include profile process 210D, companies process 220D, administrators process 230D, loading process 240D, activities process 250D and payment setup process 260D. The profile process 210D facilitates the management of a providing entity's profile. This may include, but is not limited to, contact addresses, front-end template information and phone numbers. The companies process 220D facilities the ability to create, manage and remove businesses that the providing entity may invoice. A company administrator associated with the providing entity 210A may have the ability to assign specific payment methods to purchasing entities that register with the B2B EIPP system facilitated by EIPP server 240A. The administrators process 230D may enable the providing entity's administrator to create and manage new company administrators. The loading process 240D may enable the providing entity's administrator to review the status of invoice loads into EIPP server 240A. The activities process 250D may allow a providing entity's administrator to configure specific activities that may be logged within system environment 200A, such as the logging in of users or when an invoice is paid. The payment setup process 260D may allow the creation and management of payment methods that are used within the B2B EIPP system facilitated by EIPP server 240A, by providing entity 210A.

The purchaser administration process 230B facilitated by biller manager 244A may enable each purchasing entity to administer information pertaining to their business, the people accessing the system for their business and how it pays for its invoices. FIG. 2E illustrates an exemplary view of the processes that may be performed by purchaser administration process 230B. As shown in FIG. 2E, purchaser administration process 230B may include a profile process 210E, a departments process 220E, a members process 230E, and an activities process 240E. The profile process 210E may allow for an administrator of purchasing entity 220A to manage purchasing entity profile information. This information may include, but is not limited to, address information, company contacts and the payment method that is used to pay invoices from providing entity 210A. The departments process 220E may enable purchasing entity 220A to add and modify the department hierarchy facilitated by the B2B EIPP server 240A. The members process 230E may manage authorized users who are allowed to access the B2B EIPP system facilitated by EIPP server 240A. The authorized users are individuals that may interact with invoice data for approval, dispute or payment. These users may include approvers and payers associated with purchasing entity 220A. The activities process 240E may enable an administrator associated with purchasing entity 220A to configure specific activities that should be logged within the B2B EIPP server 240A. These activities may include the logging in of users or when an invoice (or item of an invoice) is paid.

In addition to the above levels of administration, the B2B EIPP system consistent with features and principles of the present invention may be associated with predefined processes that allow purchasing entity 220A to facilitate its invoice processing. Purchasing entity 220A may modify the predefined processes or create new ones to model its specific requirements. One such predefined process may include an enrollment process that handles the purchasing entity's end user sign up and registration. This may include registering approvers and/or payers that are authorized to approve, dispute or pay the invoices.

The enrollment process may involve login screens that are presented to an end user of the purchasing entity through a browser operating on a computer system. The computer system may or may not be located at purchasing entity 220A. For example, a user who is associated with purchasing entity 220A may be remotely located from purchasing entity 220A, but may still interact with the enrollment process. The screens may include various buttons and icons to allow an end user to register using standard graphical user interface techniques. For instance, when a new user accesses the EIPP B2B system facilitated by EIPP server 240A, an ENROLL NOW button may be displayed in a login screen. Once activated by the user, the ENROLL NOW button may initiate a process that allows the user to enter personal information in an on-screen form displayed by the browser. The personal information may include, but is not limited to, name, email address, desired password and a company ID. The company ID may be provided by the user's manager prior to registering.

The enrollment process may then perform a check of the user's email address to see if the user had previously registered. If the user already has an account with the EIPP B2B system, the enrollment process may allow the user to change the password. If the user is not a registered user, the process may find the company that the user is registering with (by using the company ID), and then send a confirmation email to the user in order to verify the email address. Included in the email may be an active link that the user may use to confirm all of the personal information that is required by the EIPP B2B system to create an account.

Once the user confirms the information, the enrollment process may pass an account creation request to an administrator with the user's company, for instance purchasing entity 220A. The administrator may then use company resources to assign the user's manager. From here, the enrollment process may then move to the user's manager, where the department number and approver are assigned. Once the manager has approved the user's request, the user is enrolled into the EIPP B2B system.

Another predefined process that methods and systems consistent with the present invention may offer is a purchasing entity approval/dispute process. This process may enable a purchasing entity to model their specific business requirements to define how invoices are to be approved and/or disputed. This process may include four sub-processes, Manager Approval Process, Approver Process, Delegation Process and Approval Amount Process.

Manager Approval Process assigns an invoice initially to predefined approvers for departments listed on the invoice. As the predefined approvers approve the invoice, the invoice is assigned for approval by the initial approver's manager, as may be defined in the U & G LDAP server. This process will continue until there are no more additional approvals required.

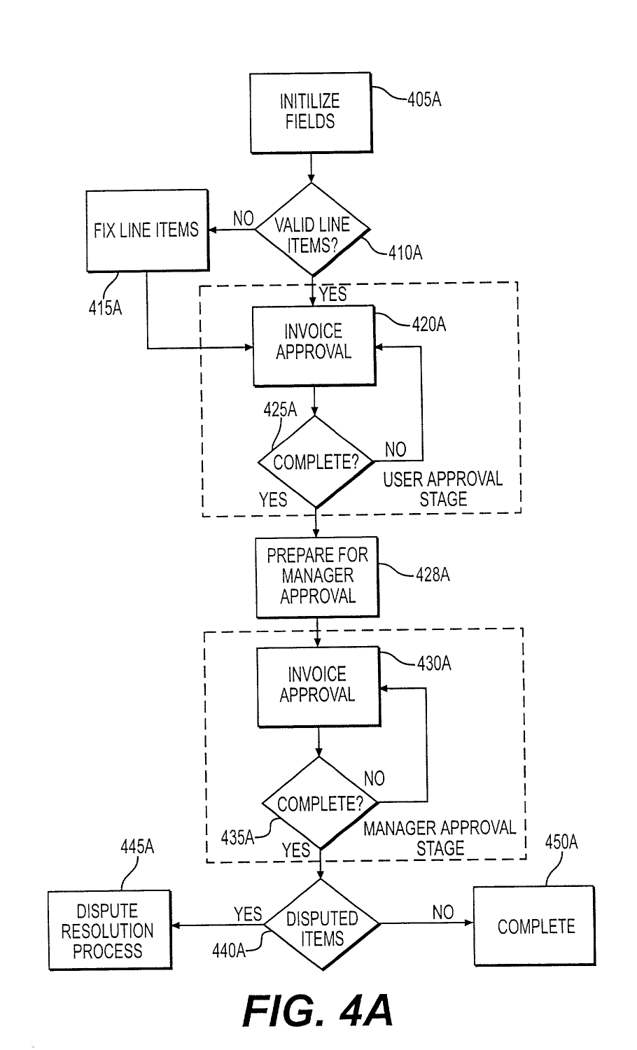

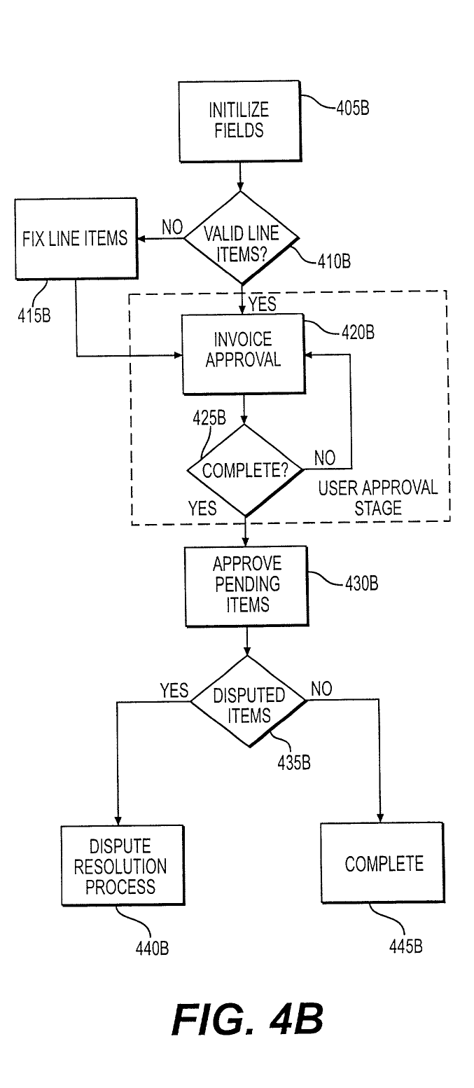

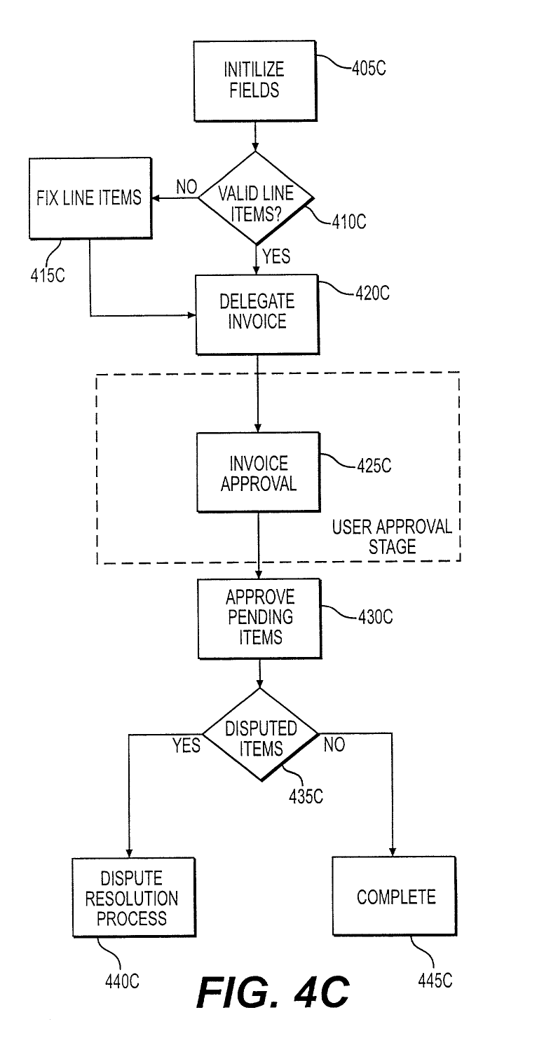

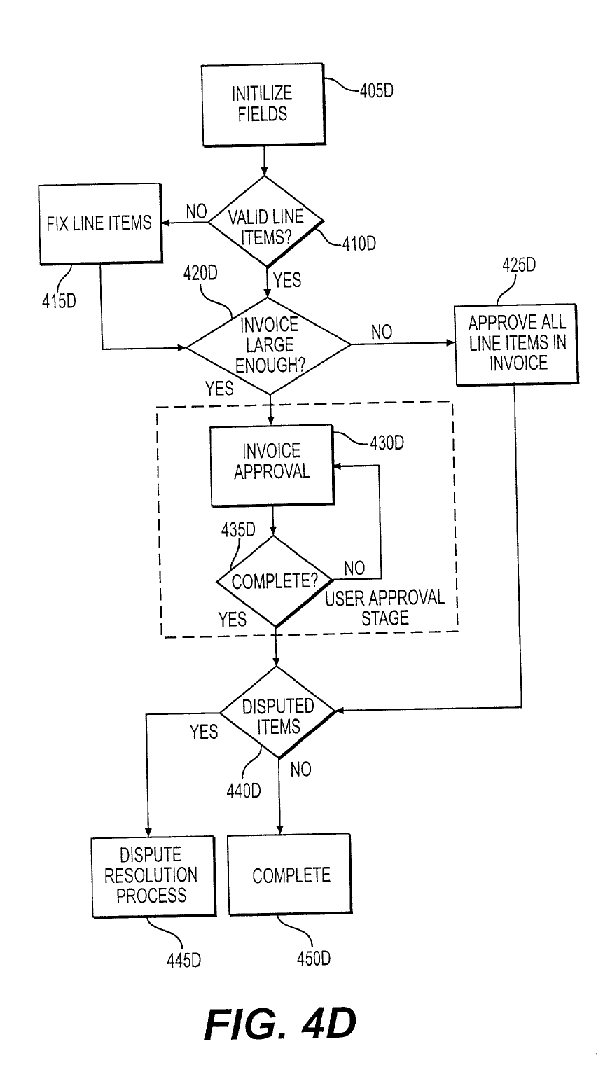

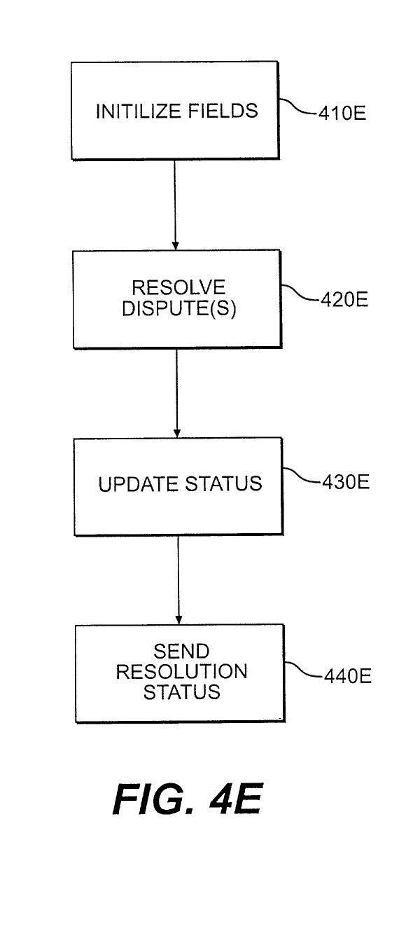

FIG. 4A illustrates an exemplary Manager Approval Process consistent with features of the present invention. Once activated, the Manager Approval Process initializes common variables that are required throughout this process (Step 405A). If there are missing department numbers on the line items of the invoice (Step 410A; NO), the invoice enters another process where the invoice is presented to a company administrator to assign the correct department numbers (Step 415A).

Once the department numbers have been assigned to each line item, the invoice is assigned to the department approvers (USER APPROVAL STAGE). An assignment script which specifies who is required to perform the approval activity is recalculated each time someone approves the invoice. Once someone approves or disputes the invoice (Step 420A), their name is removed from a list of required approvers, and the list is recalculated. The department approver cycle continues until all department approvers have approved or disputed the line items for which they responsible (Step 425A).

After the initial approver (or approvers) approves the invoice, it may require the approval of their manager (Step 425A; YES). Accordingly, an automated process re-computes the new approvers to be the manager of the previous approvers (Step 428A). A manager is allowed to override the decision of their subordinates regarding invoice line approval or dispute. As in the USER APPROVAL STAGE, the assignment script for the Manager Approval Process is recalculated each time someone approves the invoice (Step 430A). The Manager Approval Process continues until all of the higher level managers approve or dispute all relevant line items in the invoice (Step 435A).

Once the approvals are complete (Step 435A; YES), the process determines if any of the line items are marked for dispute. If there are items that are in dispute (Step 440A; YES), the process invokes a sub-process that sends the disputed items to the providing entity for resolution (Step 445A). The approved items are marked approved for payment by a designated account payable process that may be designated by the purchasing entity (Step 450A). Details of the dispute resolution process is described later with reference to FIG. 4E.

Approver Process is similar to Manager approver Process except that the invoices do not go to the approver's manager for subsequent approvals. Instead, the invoices are sent to the approver's approver as may be defined in the U & G LDAP server. An approver's approver may be different than their manager, such as a financial approver designated for a particular department.

FIG. 4B illustrates an exemplary Approver Process consistent with features of the present invention. The Approver Process may be started automatically when invoices are first loaded into EIPP server 240A. As shown in FIG. 4B, the Approver Process initializes common variables that are required throughout this process (Step 405B). If there are missing department numbers on the line items of the invoice (Step 410B; NO), the invoice enters another process where the invoice is presented to a company administrator to assign the correct department numbers (Step 415B).

Once the department numbers have been assigned to each line item, the invoice is assigned to the department approvers (USER APPROVAL STAGE). An assignment script which specifies who is required to perform the approval activity is recalculated each time someone approves the invoice. Once someone approves or disputes the invoice (Step 420B), their name is removed from a list of required approvers, and the list is recalculated. The department approver cycle continues until all department approvers have been approved or disputed the line items for which they responsible (Step 425B).

After the initial approver (or approvers) approves the invoice, it may require the approval of a designated approver. Accordingly, as with the Manager Approval Process, an automated process re-computes a new approver to be the approver of the previous approvers. A new approver is allowed to override the decision of their designated subordinate approvers regarding invoice line approval or dispute (Step 430B).

Once the approvals are complete, the process determines if any of the items are marked for dispute (Step 435B). If there are items that are in dispute (Step 435B; YES), the process invokes a sub-process that sends the disputed items to the providing entity for resolution (Step 440B). The approved items are marked approved for payment by a designated account payable process that may be designated by the purchasing entity (Step 445B). Details of the dispute resolution process is described later with reference to FIG. 4E.

The Delegation Process is a process where initially the invoice is assigned to a group of people within a purchasing entity. This group of people is responsible for reviewing the invoices and then assigning them to the correct person within the company for final approval.

FIG. 4C illustrates an exemplary Delegation Approval Process consistent with features of the present invention. The Delegation Approval Process may be started automatically when invoices are first loaded by EIPP server 240A. As shown in FIG. 4C, the Delegation Approval Process initializes common variables that are required throughout this process (Step 405C). If there are missing department number on the items of the invoice (Step 410C; NO), the invoice enters another process where the invoice is presented to a company administrator to assign the correct department number (Step 415C).

Once the department numbers have been assigned to each item, a designated company administrator may delegate the task of approving the invoice line items to a user from the company (purchasing entity) (Step 420C). The delegated user should have sufficient permission to view all the line items in the invoice. Once the invoice is delegated to a user, the process allows that user to perform approval processing (USER APPROVAL STAGE). An indication of the delegated approver may be provided to EIPP server 240A in order to allow the Delegation Process to facilitate the user approval stage. Once the delegated user approves or disputes the invoice (Step 425C), the process will look at each line item of the invoice and change the status of each line item that is pending to approved (or disputed) (Step 430C). The approved status indicator signifies that the line item has gone through the entire approval process and may used an indicator to an accounts payable approver to pay the invoice.

Once the approvals are complete, the process determines if any of the items are marked for dispute (Step 435C). If there are items that are in dispute (Step 435C; YES), the process invokes a sub-process that sends the disputed items to the providing entity for resolution (Step 440C). The approved items are marked approved for payment by a designated account payable process that may be designated by the purchasing entity (Step 445C). Details of the dispute resolution process is described later with reference to FIG. 4E.

Approval Amount Process examines an invoice and automatically approves invoices with an amount over (or under) a predetermined amount. This process enables purchasing entities to minimize the cost of reviewing and approving invoices that may not worth the time required for people within the purchasing entities to examine and approve.

FIG. 4D illustrates an exemplary Amount Approval Process consistent with features of the present invention. Once activated, the Amount Approval Process initializes common variables that are required throughout this process (Step 405D). If there are missing department numbers on the items of the invoice (Step 410D; NO), the invoice enters another process where the invoice is presented to a company administrator to assign the correct department numbers (Step 415D).

Once the department numbers have been assigned to each line item, the process checks to see if the total amount of the invoice is less than a predetermined amount (Step 420D). If the invoice total is less than the predetermined amount (Step 420D; NO), the process marks all of the line items approved and valid for accounts payable to pay (Step 425D). In another aspect of the invention, the Amount Approval Process may be implemented to check individual items for approval based on the line item amount.

If, on the other hand, the invoice amount is above the predetermined amount (Step 425D; YES), the invoice is assigned to the approvers of the departments for approval (USER APPROVAL STAGE). An assignment script which specifies who is required to perform the approval activity is recalculated each time someone approves the invoice. Once someone approves or disputes the invoice (Step 430D), their name is removed from a list of required approvers, and the list is recalculated. The department approver cycle continues until all department approvers have been approved or disputed the line items for which they responsible (Step 435D).

In another aspect of the invention, the Amount Approval Process may implement a manager approval stage, whereby after the initial approver (or approvers) approves the invoice, it may require the approval of their manager. Accordingly, an automated process re-computes the new approvers to be the manager of the previous approvers. A manager is allowed to override the decision of their subordinates regarding invoice line approval or dispute. An assignment script is recalculated each time someone approves the invoice, and approval process continues until all of the higher level managers approve or dispute all relevant items in the invoice.

Once the approvals are complete (Step 435D; YES), the process determines if any of the items are marked for dispute. If there are items that are in dispute (Step 440D; YES), the process invokes a sub-process that sends the disputed items to the providing entity for resolution (Step 445D). The approved items are marked approved for payment by a designated account payable process that may be designated by the purchasing entity (Step 450D). Details of the dispute resolution process is described later with reference to FIG. 4E.

FIG. 4E illustrates an exemplary Dispute Resolution Process consistent with features of the present invention. The Dispute Resolution Process may be used by a providing entity to handle line item disputes by a purchasing entity. The Dispute Resolution Process may be started automatically from an invoice approval process in the event any items in an invoice are disputed. Once started, a resolver context field used to store a resolver's decision regarding a dispute is initialized (Step 410E). Invoices are assigned to a group called “Resolvers” in the providing entity. Any member of this group may examine an invoice and determine if the disputes are valid (Step 420E). The resolver may select specific disputed items and decide whether or not they are valid. Once a member of the resolver group completes its review of the invoice, all items whose disputes are marked as valid have their approval status changed to Dispute Valid. Conversely, all invalid items disputes are marked as Dispute Invalid (Step 430E). Once a resolver completes its decision making, the process sends the status of the disputes to identified personal to take appropriate action within the providing entity (Step 440E). The status may be sent using an standard form of communication, including email.

In addition to the above mentioned processes, the EIPP B2B system may implement an Invoice Loading Process that facilitates the loading of invoices into EIPP server 240A. During the loading, the invoices need to be disseminated to the appropriate purchasing entity for approval. Once a loader program completes the Invoice Loading Process for taking raw XML invoice data and bringing it into the system, a Loader Done Process may be initiated. The Loader Done process examines the new invoice data and initiates the correct process for the invoice for the appropriate purchasing entity.

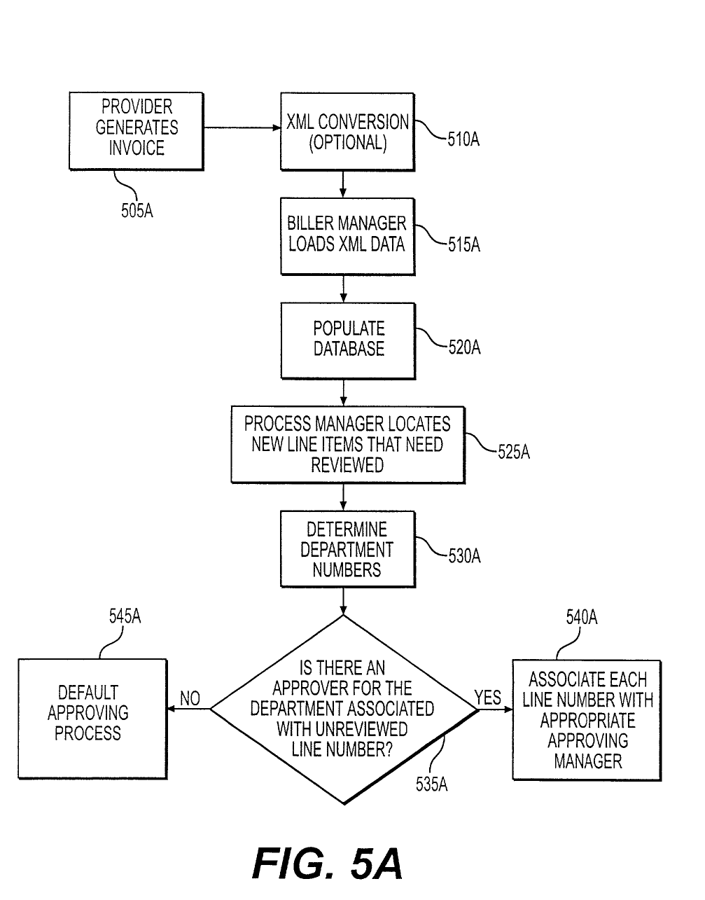

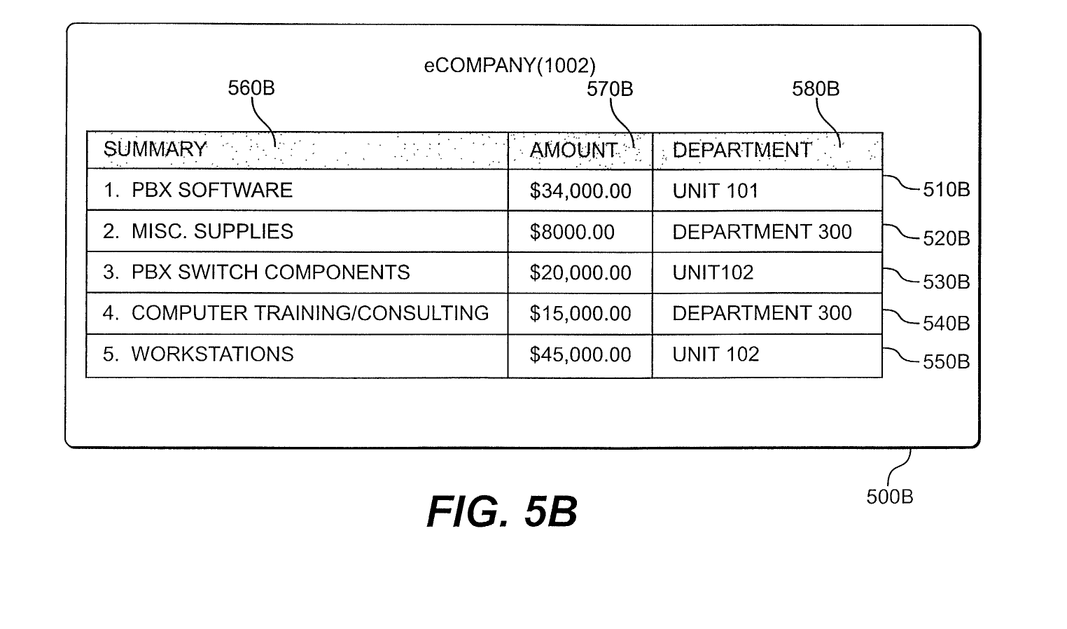

To aid in the understanding of the features and principles of the present invention, FIGS. 5A-9 describe exemplary processes and representations that may be implemented when purchasing entity 220A prepares to handle an invoice prepared by providing entity 210A. The features described in FIGS. 5A-9 may be implemented using the purchasing entity approval and dispute processes described in FIGS. 4A-4D.

As shown in FIG. 5A providing entity 210A prepares an invoice for goods and services the entity provided to purchasing entity 220A (Step 505A). FIG. 5B shows an exemplary invoice 500B generated by providing entity 210A corresponding to purchases from purchasing entity 220A. Invoice 500B is exemplary only, and may be configured in any manner deemed appropriate by providing entity 210A. As shown, invoice 500B includes a plurality of line items (510B-350B) that may represent individual purchases by purchasing entity 220A. Invoice 500B may include a summary field 560B that provides a brief description of the type of goods and/or services that was purchased. Also, an amount field 570B corresponding to the goods and/or services that were purchased maybe included in invoice 500B. In one aspect of the invention, invoice 500B may also include a department field 580B that indicates the department identifier that corresponds to a department within purchasing entity 220A that ordered the goods and/or services from providing entity 210A.

The invoice 500B may be configured into information that can be transmitted from providing entity 21A to the web server within EIPP server interface 230A. The web server may generate an optional XML conversion of the invoice information (Step 510A). This conversion enables EIPP server 240A to receive invoice data in a standard format that enables it to perform its B2B EIPP processing. Therefore, the format used by providing entity 210A to configure its invoice data is converted to a standard format using a loading program. Following the conversion process, biller manager 244A loads the XML converted data (Step 515A) and populates tables located within database 250A using JDBC 248A (Step 520A). The tables stored within database 250A may include, but is not limited to, summary tables and line item tables. Within a summary table, the information located in the summary field 560B of invoice 500B may be loaded. Within a line item table, corresponding amount and department fields 560B, 580B may be stored. In another aspect of the invention, database 250A may store the converted invoice information within a single table.

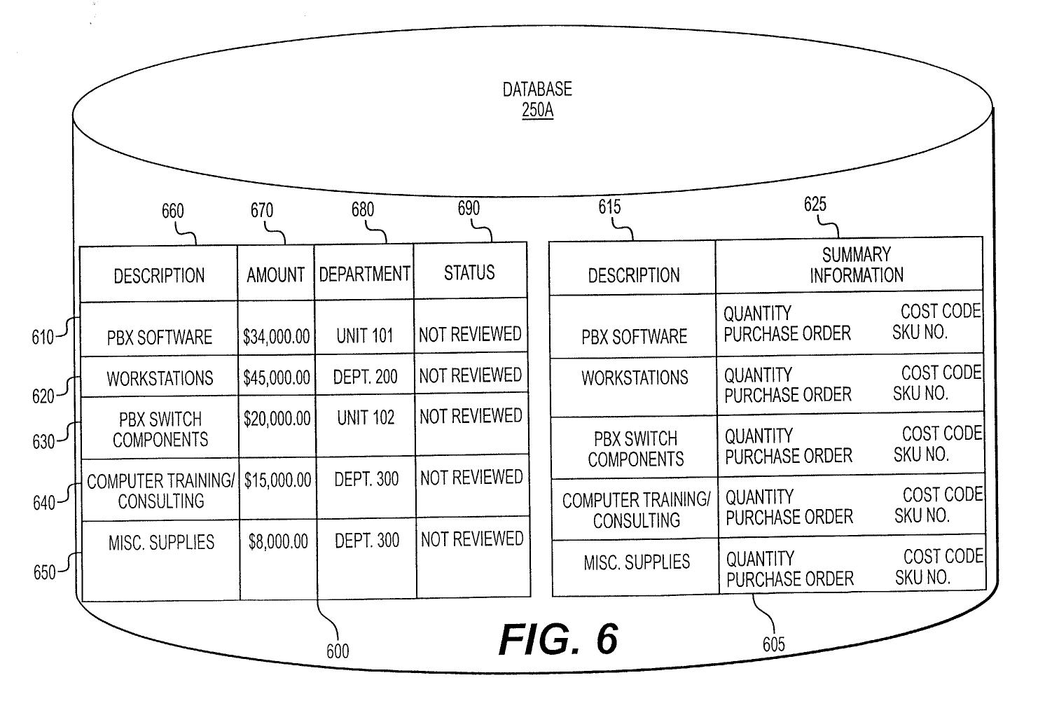

FIG. 6 shows exemplary tables that may be stored within database 250A. As shown, line item table 600 includes information similar to that shown in invoice 500B illustrated in FIG. 5B. Line item table 600 includes a plurality of line items 610-650 that correspond to line items 510B-550B. Also, line item table 600 may include a description field 660, and amount field 670 and a department field 680, similar to fields 560B, 570B and 580B shown in FIG. 5B. Additionally, line item table 600 may include a status field 690 that indicates whether a particular line item has been approved, disputed or not reviewed. Also shown in FIG. 6, summary table 605 may provide summary information associated with each line item. Field 615 may provide description information similar to field 660 of line item table 600. Also, summary table 605 may include a summary information field that includes invoice information associated with each line item such as quantity, purchase order number, cost code SKU number. The information maintained in tables 600 and 605 are exemplary and not intended to be limiting. A variety of invoice information may be maintained in these tables without departing from features and principles of the present invention.

After the invoice data is populated within database 250A, process manager 242A locates new line numbers that have not been reviewed by purchasing entity 220A. This may be performed by referring to the status field 690 of line item table 600 (Step 525A). Next, biller manager 244A determines the department identifier corresponding to each line item that has not been reviewed (Step 530A). Working together with biller manager 244A, process manager 242A then determines an approver assigned to each department identifier that has been registered by purchasing entity 220A with EIPP server 240A and stored in the U & G LDAP server (Step 535A).

In the event there is no approver associated with a given department (Step 535A; NO), a default process may be initiated (Step 545A). This process may be configured by purchasing entity 220A as a back-up process that automatically associates line items that have no designated approver with a default entity designated by purchasing entity 220A. The designated entity may be a single approver, or may be a group of approvers, as designated by purchasing entity 220A.

On the other hand, if an approver has been associated with a particular department identifier (Step 535A; YES), process manager 242A creates an association between each line item that has not been reviewed and the designated approver for the department corresponding to the new line items (Step 540A). Coordinated processing between process manager 242A and biller manager 244A then stores the line item data, along with all associated purchase information such as summary data, amount, date of purchase etc., into database 250A. The stored information may be used for the generation of an in-box corresponding to each approver. An in-box may be configured using e-mail type applications that interact with web browser applications such that approvers or managers of purchasing entity 220A may determine whether any new line items or invoices need approval. For example, referring to the invoice data illustrated in FIG. 6, process manager 242A would associate line items 610 and 630 with the designated approver for units 101 and 102, respectively. For illustration purposes, manager 100 has been registered as the approver for all invoices associated with units 101 and 102 and department 100, as shown in FIG. 1B. Accordingly, process manager 242A may associate line items 610 and 630 with manager 100. Additionally, process manager 242A may associate line item 620 with manager 200 (the designated approver for department 200), and associate line items 640 and 650 with manager 300 (the registered approver for department 300).

The processing of line items within an invoice, as described above, may enable EIPP server 240A to provide purchasing entity 220A and providing entity 210A with the opportunity to manage billing presentment and payment operations down to line items within particular invoices. This level of granularity not only enables the businesses that interact with each other better approval and dispute resolution capabilities, it also reduces the amount of information that is transferred between selected entities in a given transmission. That is, instead of manager 100 receiving all of the line items included in invoice 600, only information associated with line items 610 and 630 are available to manager 100.

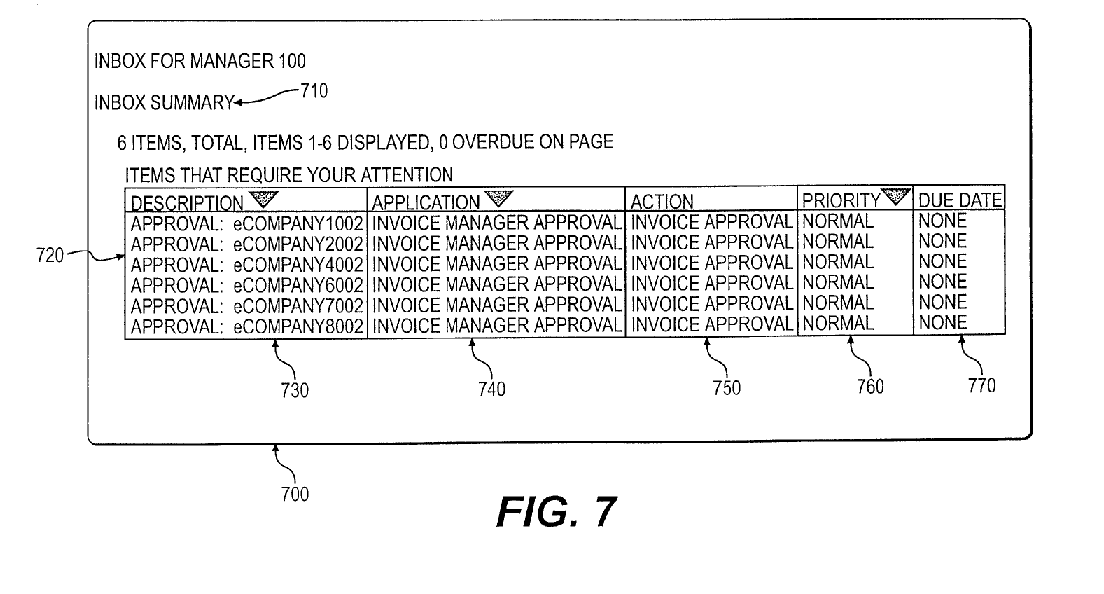

FIG. 7 shows an exemplary in-box 700 associated with manager 100 of purchasing entity 220A. Manager 100 illustrated in FIG. 7 corresponds to manager 100 of eCompany, as depicted in FIG. 1A. In-box 700 is generated by process manager 242A when manager 100 issues a request to EIPP server 240A to review invoices associated with department 100. As shown in FIG. 7, in-box 700 may include an in-box summary portion 710 that describes the total number of invoices that include new line items that have not been reviewed. in-box 700 may also include a listing 720 that includes the invoices that need reviewed by manager 100. in-box 700 may also include fields 730-770 that provide information associated with each invoice. Field 730 may provide a brief description of each invoice that needs reviewed, such as invoice number. Field 740 may provide the application that pertains to the workflow application that is being executed by EIPP server 240A. Field 750 may describe the type of action that is required by manager 100, such as invoice approval. Field 760 may designate a priority level associated with an invoice and field 770 may indicate a particular due date from which an invoice should be reviewed. The fields and configuration of in-box 700 illustrated in FIG. 7 are exemplary only and are not intended to be limiting. Any number of configurations and fields may be implemented without departing from the features and principles of the present invention.

In another aspect of the invention, EIPP server 240A may be configured to create a table of associations between an approver and line items. This table may be stored in database 250A and accessed when the approver requests to perform approval or dispute operations consistent with features of the present invention.

After creating associations between approvers and line items, EIPP server 240A may send a notification message to each approver in purchasing entity 220A that has new line items to be reviewed. The notification may be sent via email, or using wireless and wireline techniques, as well as any other form of notification that purchasing entity 220A desires to have approvers notified. Once an approver decides to perform approval operations, they may access an in-box by contacting EIPP server 240A through the web server operating in interface 230. The B2B EIPP system illustrated in FIG. 2A may be HTML based. Therefore all access to EIPP server 240A may be through a standard browser operating at the purchasing and providing entities, or ay a computer system operated by an approver. Accordingly, an approver associated with purchasing entity 220A may utilize a standard browser to access the web server and EIPP server 240A to access their in-box and perform approval or dispute functions.

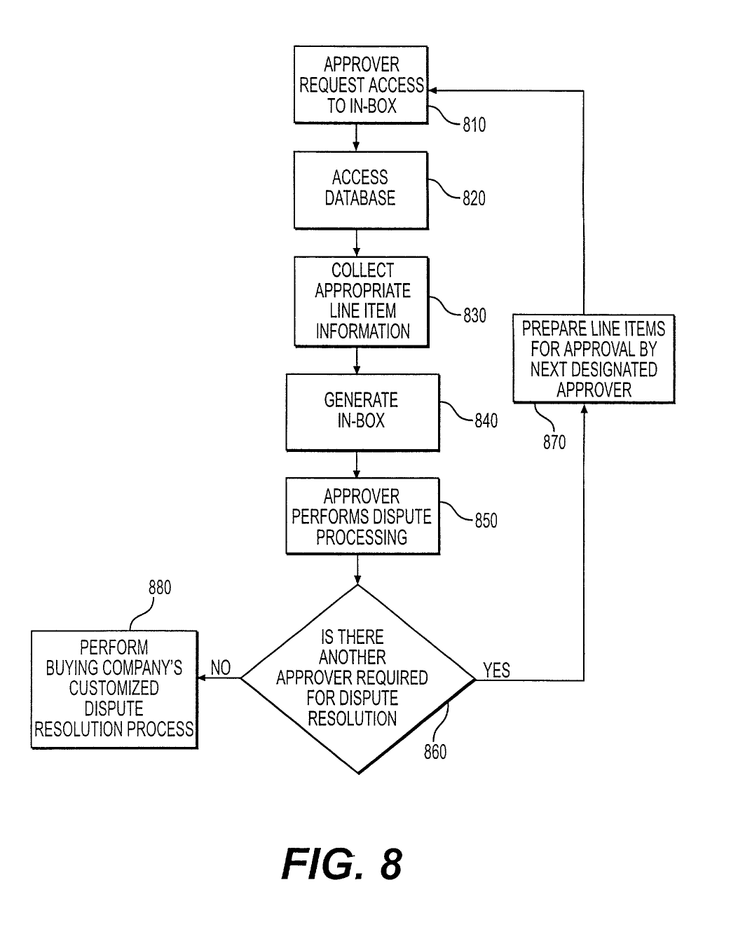

FIG. 8 illustrates an exemplary process associated with this aspect of the invention. The processes described with respect to FIG. 8 may be implemented using the approval processes previously described and illustrated in FIGS. 4A-4D. As shown in FIG. 8, an approver, for example manager 100, requests to access their in-box using a standard browser operating on a computer system. The computer system may or may not be located at purchasing entity 220A (Step 810). The web server operating in interface 230A receives the request and passes it to EIPP server 240A for processing. Billing manager 244A then accesses database 250A (Step 820) to collect line item information for the generation of an in-box 700 associated with manager 100 (Step 830). Coordinated processing between process manager 242A and biller manager 244A enable EIPP server 240A to make available an in-box for access by the approver (Step 840). For instance, the U & G LDAP server may be accessed to retrieve information associated with an approver. In the above example, manager 100 is an approver for department 100, thus the line items associated with department 100 are retrieved from database 250A for generation of the in-box.

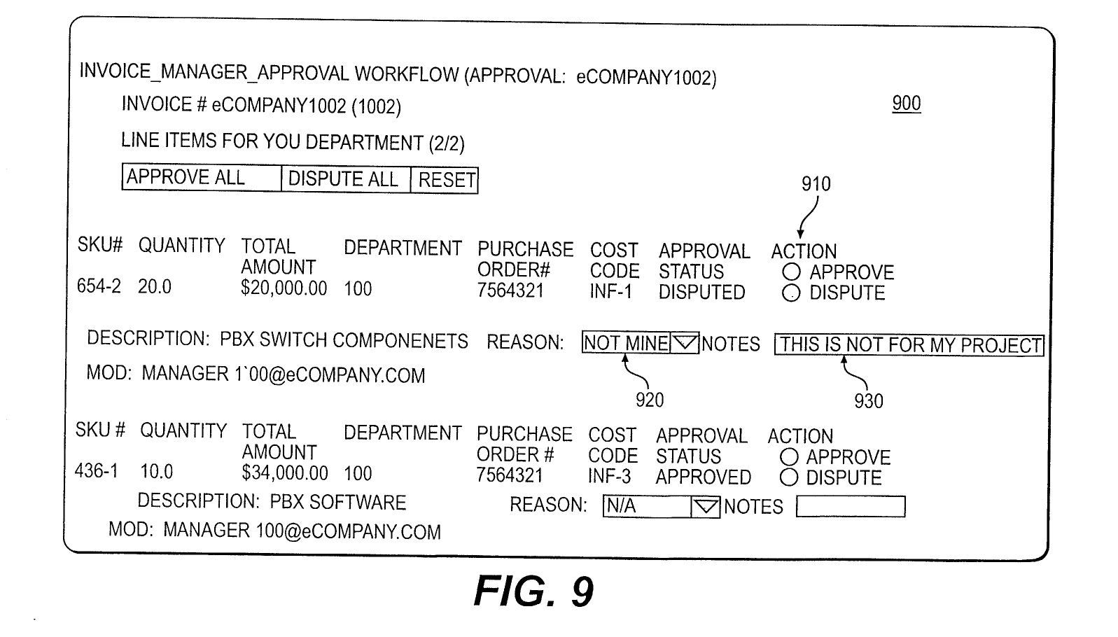

Following the example above, once in-box 700 is created, it is sent to the approver for display through the browser operating on the computer system that manager 100 is utilizing to access EIPP server 240A (Step 840). After in-box 700 is displayed, manager 100 may select an invoice shown in listing 720 to view the line items associated with the selected invoice and perform approval/dispute processing (Step 850). FIG. 9 shows an exemplary invoice associated with the first invoice listed in listing 720 of invoice 700 (“eCompany1002”).

As shown, FIG. 9 includes an invoice 900 of line items 610 and 630 included in invoice 600 (labeled “eCompany 1002”) that correspond to department 100. Invoice 900 may include detailed information associated with each line item such as a SKU number, quantity, total amount of line item purchase, approving department, purchase order number, cost code associated with purchasing entity 220A and approval status. Manager 100 may review each line item and determine whether they should be approved for payment or not. If for example, manager 100 determines that the PBX switch components indicated in the first line item was not an authorized purchase for department 100, that line item may be disputed. Manager 100 may select an action selector 910 that indicates manager 100's decision to dispute the purchase. In one aspect of the invention, manager 100 may also select a predefined reason code from a drop down menu 920 and supplement this code with a brief description of the reason for the dispute in input box 930. The configuration of invoice 900 is exemplary only and is not intended to be limiting. Accordingly, any number of configurations, description fields, reason codes and user-interactive windows may be implemented that are consistent with features and principles of the present invention.

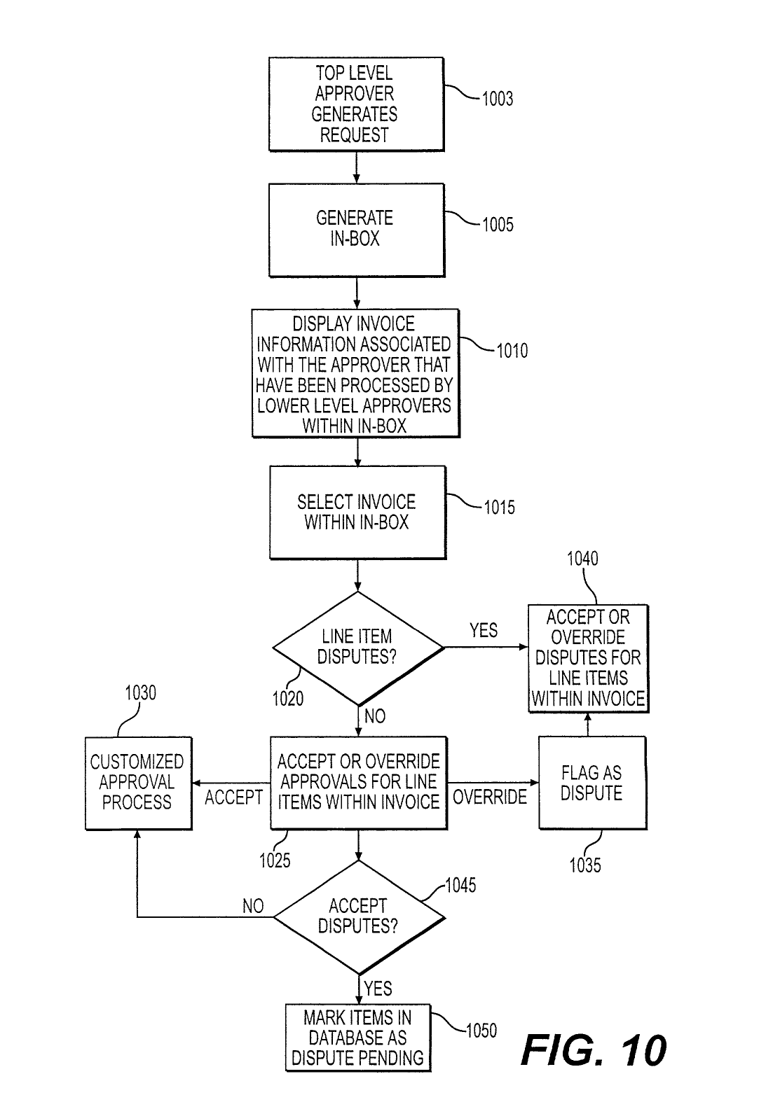

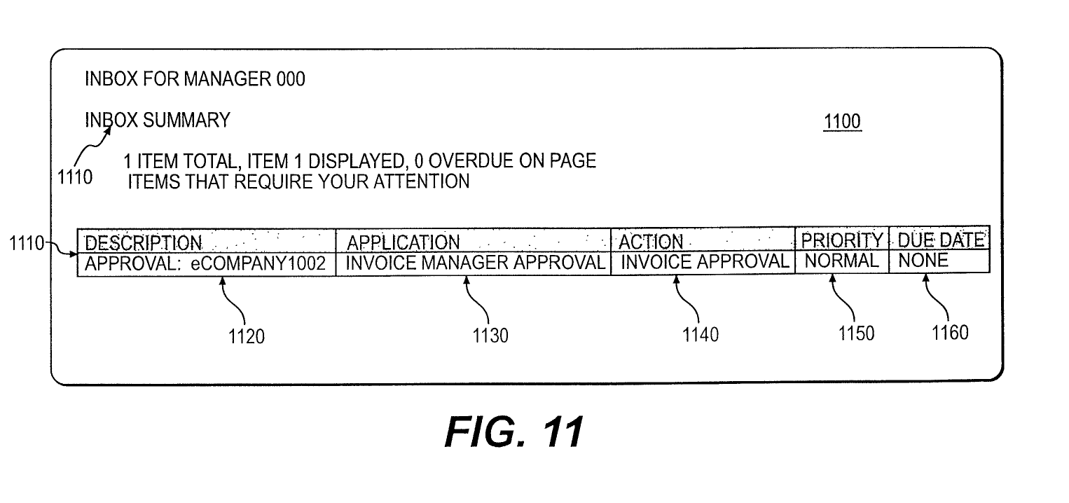

Referring back to FIG. 8, once manager 100 has completed approval/dispute processing for each line item in invoice 900, the reviewed invoice data may be submitted to EIPP server 240A using standard network communication techniques. The submitted reviewed invoice data is passed to EIPP server 240A through the web server operating in interface 230. Process manager 242A may analyze the reviewed invoice with an approval hierarchy that may be set up by purchasing entity 220A to determine whether manager 100 has an approver designated to approve department 100's invoices (Step 860). In the event the approval hierarchy set up by purchasing entity 220A (such as the one depicted in FIG. 1B) indicates that another approver is required to review the subordinate approver's (manager 100) invoice (Step 860; YES), process manager 242A prepares the line items indicated in the reviewed invoice for placement in a generated in-box associated with the other approver (Step 870). Thus, another approver may request access to their in-box and perform approval/dispute processing in a manner similar to that performed by manager 100. However, in the event the approver (manager 100) was the upper-most approver in the hierarchical approval scheme set-up by purchasing entity 220A, (Step 860; NO), process manager 242A initiates a purchasing entity's customized dispute resolution process (Step 880). Details of an exemplary customized approval/dispute process will be described later with reference to FIGS. 10 and 11.

As described, methods and systems consistent with features and principles of the present invention, enable a B2B EIPP system to filter and process line items within invoices based on a customized approval hierarchy. This process eliminates the disadvantages of conventional B2B EIPP systems that require entire invoices to be exchanged between a purchasing and providing entity. Furthermore, with the implementation of the purchasing entity approval processes previously described, a purchasing entity may customize the manner by which the approval workflow process is performed by EIPP server 240A. For instance, by implementing an approval amount process (as shown in FIG. 4E), a department may bypass particular line items that are below or above predefined dollar amounts. This process is especially advantageous to departments or companies that receive a large amount of invoices each day because it enables these entities to reduce transactional costs associated with performing approval/dispute processing for these line items.

FIG. 10 shows an exemplary process associated with an approver with top-level review authority in purchasing entity 220A performing a customized dispute resolution process. The process described in FIG. 10 may be implemented using the processes previously described and illustrated in FIGS. 4A-4C. For exemplary purposes only, manager 000, as depicted in FIGS. 1A and 1B, will be considered the top-level approver for purchasing entity 220A. Therefore, manager 000 is designated as an approver for manager 100. As shown in FIG. 10, manager 000 may request access to their in-box by sending a request to EIPP server 240A. The request may be implemented by manager 000 logging-in using standard network login procedures (Step 1003). In one aspect of the invention, prior to logging-in, manager 000 may be sent a notification by EIPP server 240A when invoices have been reviewed by subordinate approvers. The notification may be sent via email, or by using wireless and wireline techniques, or any other form of notification technique that purchasing entity 220A desires to implement. With regard to the exemplary invoices described above, after manager 100 submitted invoice 900, EIPP server 240A may be configured to send a notification message to an email account associated with manager 000. Accordingly, when manager 000 accesses their email account, a message indicating the review of invoice 900 by manager 100 may be presented. In response, manager 000 may then generate a request to view their in-box.

Once EIPP server 240A receives the request from manager 000, process manager 242A collects the appropriate information to generate the in-box associated with manager 000 (Step 1005). As with the generated in-box 700 associated with manager 100, the in-box corresponding to manager 000 may include all invoices that manager 000 has the authority to review. FIG. 11 shows an exemplary in-box associated with manager 000.

As shown in FIG. 11, in-box 1100 includes an in-box summary 1110 that may indicate the total number of items that have been reviewed by a number of approvers. in-box 1100 also includes a listing 1120 that presents the invoices that have been reviewed by approvers that manager 000 is responsible for reviewing. As shown in FIG. 11, listing 1120 includes the invoice (eCompany1002) that manager 100 previously reviewed and submitted to EIPP server 240A. As with in-box 700 illustrated in FIG. 7, invoice 1100 may also include fields 1130-1170 that provide information associated with each invoice. Field 1130 may provide a brief description of each invoice that needs reviewed, such as invoice number. Field 1140 may provide the application that pertains to the workflow application that is being executed by EIPP server 240A. Field 1150 may describe the type of action that is required by manager 000, such as invoice approval. Field 1160 may designate a priority level associated with an invoice and field 1170 may indicate a particular due date from which an invoice should be reviewed. The configuration of in-box 1100 illustrated in FIG. 11 is exemplary only and are not intended to be limiting. Any number of configurations and fields may be implemented without departing from the features and principles of the present invention.

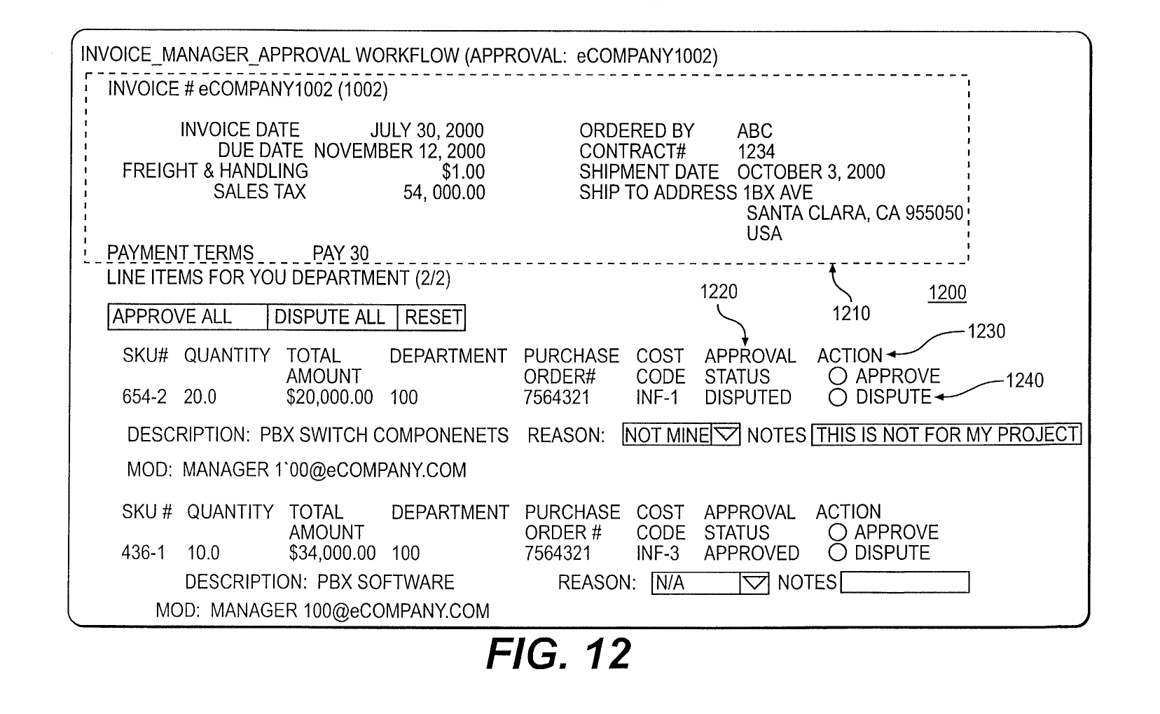

Referring back to FIG. 10, once in-box 1100 is displayed, manager 000 may view the invoices listed therein and select the particular invoice that they wish to review (Step 1015). In this case, invoice eCompany1002 would be selected by manager 000 because it is the only invoice provided in listing 1120. EIPP server 240A receives manager 000's selection and processes it by generating a line item invoice and sending it to the manager's browser for display. FIG. 12 illustrates an exemplary line item invoice 1200 associated with the invoice eCompany1002 depicted in FIG. 11.

As shown in FIG. 12, line item invoice 1200 includes detailed information associated with the line items of invoice 500B, shown in FIG. 5B, that correspond to manger 100 and department 100. The line item invoice 1200 may include similar information that was provided in invoice 900 associated with manager 100. This includes SKU number, quantity, total amount of line item purchase, approving department, purchase order number, cost code associated with purchasing entity 220A and approval status. Additional detailed information 1210 associated with the invoice may also be included in line item invoice 1200. Approval status 1220 may indicate to manager 000 a subordinate approver's decision to dispute or approve particular line items. As shown in FIG. 12, approval status 1220 indicates to manager 000 that the approver for department 100 (manager 100) has disputed a line item in invoice eCompany1002. As with invoice 900, invoice 1200 may also include reason codes and description blocks for indicating the reason the lower-level approver disputed a particular line item. Manager 000 reviews invoice 1200 to determine whether they are going to approve or dispute (reject) the subordinate approver's decision associated with each line item (Step 1020).

In the event line item invoice 1200 does not include a dispute (Step 1020; NO), manager 000 may decide to accept or override approvals made by manager 100 in any line item listed in invoice 1200 (Step 1025). In one aspect of the invention, if manager 000 decides to accept a line item, the appropriate action icon 1230 may be selected to indicate the approval. In the event manager 000 decides to accept each line item in invoice 1200 (Step 1025; ACCEPT), a customized post-approval process may be initiated (Step 1030). This may include making available information corresponding to the invoice 1200 to one or more payers in purchasing entity 220A for payment processing. Payers may also have associated in-boxes managed by EIPP server 240A that may include the submitted invoice information from a approver. The manner by which purchasing entity 220A configures a payment process may vary depending on the requirements of the company, and is not limited to the above examples.

On the other hand, if manager 000 decides to dispute (override) a particular line item in invoice 1200 (Step 1025; OVERRIDE), process manager 242A may flag the line item rejected by manager 000 as a disputed line item in invoice 1200 (Step 1035). Processing then proceeds to Step 1040.

At Step 1040, manager 000 may decide to accept or dispute (override) any disputes that are indicated in invoice 1200. If manager 000 decides to override any disputed items by manager 100 (Step 1045; NO), the customized payment process defined by purchasing entity 220A may be initiated, as previously described (Step 1030). One reason for initiating the payment process is because manager 000 is considered the top-level approver in the exemplary approval hierarchical structure set-up by purchasing entity 220A. Accordingly, if manager 000 decides to approve all of the line items in a particular invoice—even those line items that have been disputed by a subordinate manager—the decision by manager 000 may be considered final, and payment of the invoice is authorized.

However, if manager 000 decides to accept a disputed line item in invoice 1200 (Step 1045; YES), EIPP server 240A may update database 250A to indicate this in preparation for a dispute resolution process between purchasing entity 220A and providing entity 210A (Step 1050). For example, if manager 000 decides to accept the decision by manager 100 to dispute the first line item for PBX Switch Components, the dispute action icon 1230 may be selected. In this case, once this submission was received and processed by EIPP server 240A, process manager 242A, possibly working with biller manager 244A, may access database 250A to toggle the status field 690 of line item 630 (associated with the line item in invoice 1200 for PBX Switch Components). The modification of the value in status field 690 enables EIPP server 240A to indicate a disputed or rejected line item. Processes manager 242A may perform this function for every line item in any particular invoice that has been disputed by a particular upper management approver. Once manager 000 has completed the review of invoice 1200, the invoice information is submitted to EIPP server 240A and manager 000 may log-off from the B2B EIPP system.

In addition to the above description, the approval/dispute process associated with a upper-management approver may be configured as basic or complex as purchasing entity 220A desires. For instance, in one aspect of the invention, in the event an approver overrides a subordinate approver's decision on a line item, process manager 242A may re-route the overridden line item back to subordinate approver's in-box for subsequent processing. Additionally, purchasing entity 220A may also implement an approval amount process that allows process manager 242A to automatically approve line items over or under a predefined dollar amount that have been approved by subordinate approvers. There are a variety of options available to purchasing entity 220A for configuring an approval/dispute process and are not limited to the examples described above.

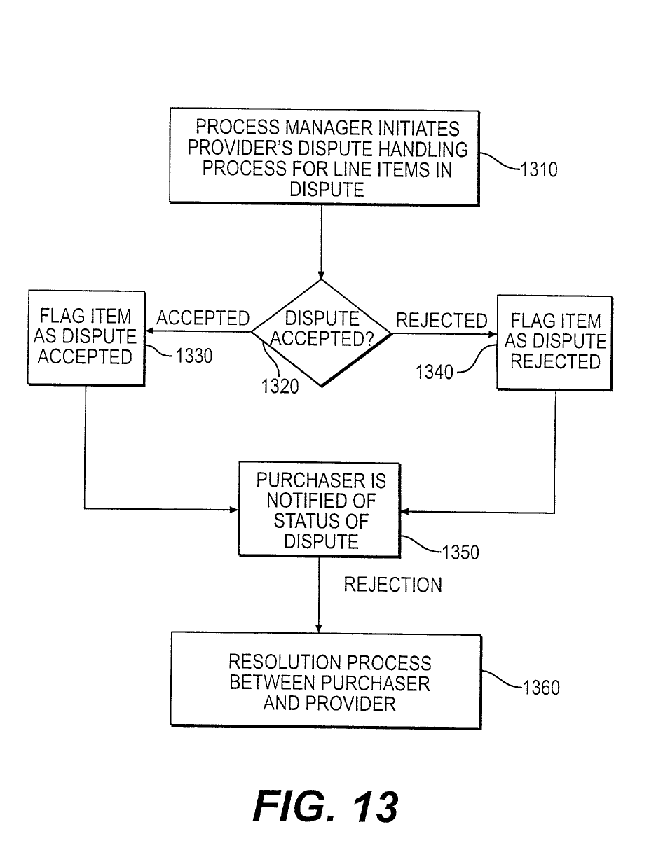

FIG. 13 shows an exemplary dispute resolution process consistent with features and principles of the present invention. The process described in FIG. 13 may be implemented using the Dispute Resolution Process previously described and illustrated in FIG. 4E. As shown in FIG. 13, process manager 242A may initiate a dispute resolution process in the event database 250A includes an invoice with line items that have been flagged as disputed by a particular upper management approver (Step 1310). The dispute resolution process may be configured by providing entity 210A to facilitate a coordinated process of handling disputes with purchasing entity 220A. The dispute resolution process may involve a variety of workflow processes that allow providing entity 210A to determine whether or not a line item disputed by purchasing entity 220A is accepted.

In performing its dispute resolution process, providing entity 210A may accept or reject a line item that has been disputed by an approver corresponding to purchasing entity 220A. If accepted, (Step 1320; ACCEPTED), the line item may be flagged by process manager 242A as accepted and this indication may be stored in a line item table associated with providing entity 210A in database 250A (Step 1330). In one aspect of the invention, providing entity 210A may generate a new invoice to reflect the accepted dispute by purchasing entity 220A. Information associated with the new invoice may then by provided to EIPP server 240A for subsequent review by approvers within purchasing entity 220A. However, if providing entity 210A rejects a disputed line item (Step 1320; REJECTED), the line item may be flagged as rejected in a similar table (Step 1340). In either case, once providing entity 210A has decided on a line item dispute, process manager 242A may generate and make available a notification to a designated person within purchasing entity 220A indicating the providing entity 210A decision (Step 1350). This notification may be presented using a number of techniques including, but not limited to, email, wireless notifications, wireline notifications, and any other form of communication that purchasing entity 220A desires to implement. The notification may take place through EIPP server 240A. Following the notification of a rejected line item, providing and purchasing entities 210A, 220A may initiate a resolution process that may involve a direct interface between the two. This may include direct contact between designated personal for each entity to resolve the disputed line item. EIPP server 240A may facilitate communications between the two entities through the web server operating in interface 230, in the event electronic communications is involved in such resolution.

As described, the above dispute resolution process facilitated by methods and systems consistent with the present invention enable EIPP server 240A to recognize disputed line items within a given invoice and provide notification to both a provider of goods and/or services and a purchaser of these goods and/or services, in order to facilitate resolution procedures between these two entities. The resolution process may enable either entity to decide whether its worth the time to dispute a given line item, based on a plurality of factors including the amount of the item's purchase and the type of goods and/or services involved. This line item granularity prevents a company from having to place an entire invoice on hold while a disputed line item within the invoice is being resolved. Accordingly, a providing entity may utilize the features of the present invention to obtain payment for a portion of an invoice while disputing another, thus giving the providing entity funds that would not be normally available if the entire invoice had to be processed through a dispute resolution procedure.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A method for facilitating electronic business transactions, comprising:
providing an invoice including a plurality of entries, each entry associated with a type of item; and
for each entry,
(i) determining an individual with authority to approve the entry based on the associated item type,
(ii) making the entry available to the determined individual, and
(iii) receiving an indication from the determined individual reflecting a decision on whether to approve the entry,
wherein entries that the individual does not have authority to approve are not made available to the individual.

2. The method of claim 1, wherein each associated item type identifies a respective purchasing entity, and wherein determining an individual with authority to approve the entry based on the associated item type includes:
determining an association between an individual and a respective purchasing entity identified by the entry type; and
determining an individual with authority to approve the entry based on the determined association.

3. The method of claim 1, further comprising:
for each entry,
(iv) determining a second individual with authority to approve the decision reflected by the received indication;
(v) making the entry and indication available to the second individual; and
(vi) receiving a second indication from the second individual reflecting a second decision concerning the entry.

4. The method of claim 1, wherein a second individual is authorized to approve each entry included in the invoice, and wherein the method further comprises:
making each entry included in the invoice available to a second individual for further approval after receipt of an indication reflecting an approval or dispute or the entry.

5. A method for facilitating electronic business transactions, comprising:
providing an invoice including a plurality of entries;
determining a value of the invoice; and
automatically approving all of the entries included in the invoice based on the determined value.

6. A method for facilitating electronic business transactions, comprising:
providing an invoice including a plurality of entries, each entry associated with a type of item;
determining a value of each entry included in the invoice;
identifying for each entry an approver with authority to approve the entry based on the associated item type;
automatically approving one or more entries included in the invoice based on the determined value of each approved entry; and
making one or more entries available to a corresponding approver based on the available one or more entries' determined value, wherein each entry that is made available excludes entries that the corresponding authorized approver does not have the authority to approve.

7. The method of 6, further comprising:
receiving an indication from each corresponding approver reflecting a decision on whether to approve each entry that the corresponding approver has the authority to approve.

8. The method of claim 6, wherein automatically approving one or more entries included in the invoice based on the approved entries' determined value includes:
automatically approving each entry included in the invoice that has a determined value below a predetermined value.

9. The method of claim 6, wherein making one or more entries available to a corresponding approver based on the available one or more entries' determined value includes:
making each entry that has a determined value above a predetermined value available to a corresponding authorized approver.

10. A method for facilitating business transactions between a providing entity and a purchasing entity, comprising:
providing, by the providing entity, an invoice including a plurality of items;
determining, for each item included in the invoice, a corresponding approver with authority to approve the item; and
facilitating a review process for each item based on the determination, wherein the review process is defined by the purchasing entity.

11. The method of claim 10, wherein the review process includes:
making information on each item available to the corresponding approver, wherein each item that is made available excludes items that the corresponding approver does not have the authority to approve; and
receiving an indication from each corresponding approver reflecting a decision on whether to approve items that have been made available to the corresponding determined approver.

12. The method of claim 10, wherein the review process includes:
automatically approving each item included in the invoice based on a value of the invoice.

13. The method of claim 10, wherein the review process includes:
automatically approving each item included in the invoice based on a value of the item.

14. The method of claim 10, wherein the review process includes:
receiving an indication of a delegated approver with authority to approve one or more items included in the invoice; and
making the one or more items available to the delegated approver, wherein the one or more items that are made available excludes items that the delegated approver does not have the authority to approve.

15. A method for facilitating business transactions, comprising:
receiving information reflecting an invoice with a plurality of items; and
directing individual items to respective approvers such that each respective approver receives only items that the respective approver is authorized to review.

16. A method for facilitating business transactions, comprising:
requesting access to invoice information associated with an invoice including a plurality of items;
accessing the invoice information that includes information on only items included in the invoice that are authorized for review; and
generating an indication reflecting a decision one whether to approve each authorized item.

17. The method of claim 16, wherein the invoice information is reflected in an in-box, and requesting access to the invoice information includes:
requesting access to the in-box in response to an indication of the availability of the invoice information reflected in the in-box.

18. The method of claim 16, wherein the invoice information is reflected in an in-box, and wherein accessing the invoice information includes:
accessing the in-box.

19. The method of claim 16, wherein the invoice information is reflected in an in-box, and generating an indication includes:
generating the indication by receiving selections on whether to approve each authorized item reflected in the in-box.

20. A method for facilitating electronic business transactions, comprising:
receiving profile information associated with a user;
receiving an indication reflecting the assignment of the user's approver status based on the profile information;
assigning an entity identifier to the user based on the approver status, wherein the identifier indicates an entity within a providing entity that purchases items from a purchasing entity; and
assigning the user as an approver with the authority to approve the purchases reflected in entries included in an invoice provided by the providing entity.

21. A method for facilitating electronic business transactions in a system including a purchasing entity that includes one or more sub-entities, and a providing entity, the method comprising:
receiving a notification that an invoice including one or more line items has been provided by the providing entity;
requesting access to information associated with the invoice;
receiving line item information associated with selected line items of the one or more line items included in the invoice;
performing a dispute/approval process on the line item information; and
generating an indication reflecting results of the dispute/approval process.

22. The method of claim 21, wherein an approver is associated with each sub-entity of the purchasing entity, and the notification is directed to approvers who are associated with sub-entities that are indicated in line items included in the invoice, and wherein requesting access to information includes:
generating, by each approver that has received a notification, a request to access information associated with the invoice.

23. The method of claim 22, wherein receiving line item information associated with selected line items of the one or more line items includes:
providing line item information to respective approvers based on the authority of the respective approvers to approve the selected line items included in the invoice, wherein each respective approver is not presented with line item information associated with line items the respective approver is not authorized to approve.

24. The method of claim 21, wherein performing a dispute/approval process on the line item information includes:
receiving an indication reflecting a dispute or approval of each selected line item.

25. The method of claim 21, wherein performing a dispute/approval process on the line item information includes:
receiving an indication reflecting a dispute of a set of the selected line items; and
receiving a second indication reflecting an approval of a second set of the selected line items.

26. A system for facilitating electronic business transactions, comprising:
a providing entity for providing one or more invoices associated with one or more purchasing entities, wherein the one or more invoices each include one or more line items; and
a server for receiving the one or more invoices from the providing entity, determining an approver for each line item included in the one or more invoices, making available line item data associated with each one of the one or more line items to the approver(s), wherein each one of the approvers has viewing access restricted to line item data associated with line items that they authorized to review.

27. The system of claim 26, wherein the server determines an approver for each line item included in the one or more invoices based on one or more approver hierarchies that associate approvers with sub-entities corresponding to the one or more purchasing entities.

28. The system of claim 27, wherein each of the one or more providing entities are associated with a separate approver hierarchy that indicates approvers that are associated with sub-entities within each respective providing entity.

29. The system of claim 26, wherein the server consists of one or more servers.

30. The system of claim 26, wherein the server is configured to receive a request from each approver to access information associated with one or more line items that the approver is authorized to review, and makes available the information to the approver in response to the request.

31. A method for facilitating business transactions between a providing entity and a purchasing entity, comprising:
providing, by the providing entity, an invoice including a plurality of items; and
determining, for each item included in the invoice, a corresponding approver with authority to approve the item.

32. A computer-implemented method for facilitating dispute handling for invoices reflecting purchases of goods and services, comprising:
storing data representing an invoice with a plurality of line items;
permitting access to at least a portion of the data by an individual authorized to review a set of line items selected from the plurality of line items based on stored profile data associated with the individual; and
receiving decision data reflecting a decision by the authorized individual to dispute one of the selected line items.

33. The computer-implemented method of claim 32, wherein the stored profile data reflects the individual's authority to review the set of line items.

34. The computer-implemented method of claim 32, wherein the set of line items were reviewed by a second individual and the stored profile data reflects the individual's authority to review the set of line items.

35. The computer-implemented method of claim 32, further comprising:
permitting access to the disputed selected line item by a second individual authorized to review the set of line items.

36. The computer-implemented method of claim 32, wherein permitting access includes:
excluding access to the portion of the data by a second individual authorized to review a second set of line items selected from the plurality of line items based on stored profile data associated with the second individual.

37. A computer-readable medium including instructions for performing a method, when executed by a processor, for facilitating electronic business transactions, the method comprising:
providing an invoice including a plurality of entries, each entry associated with a type of item; and
for each entry,
(i) determining an individual with authority to approve the entry based on the associated item type,
(ii) making the entry available to the determined individual, and
(iii) receiving an indication from the determined individual reflecting a decision on whether to approve the entry,
wherein entries that the individual does not have authority to approve are not made available to the individual.

38. The computer-readable medium of claim 37, wherein each associated item type identifies a respective purchasing entity, and wherein determining an individual with authority to approve the entry based on the associated item type includes:
determining an association between an individual and a respective purchasing entity identified by the entry type; and
determining an individual with authority to approve the entry based on the determined association.

39. The computer-readable medium of claim 37, wherein the method further comprises:
for each entry,
(iv) determining a second individual with authority to approve the decision reflected by the received indication;
(v) making the entry and indication available to the second individual; and
(vi) receiving a second indication from the second individual reflecting a second decision concerning the entry.

40. The computer-readable medium of claim 37, wherein a second individual is authorized to approve each entry included in the invoice, and wherein the method further comprises:
making each entry included in the invoice available to a second individual for further approval after receipt of an indication reflecting an approval or dispute or the entry.

41. A computer-readable medium including instructions for performing a method, when executed by a processor, for facilitating electronic business transactions, the method comprising:
providing an invoice including a plurality of entries;
determining a value of the invoice; and
automatically approving all of the entries included in the invoice based on the determined value.

42. A computer-readable medium including instructions for performing a method, when executed by a processor, for facilitating electronic business transactions, comprising:
providing an invoice including a plurality of entries, each entry associated with a type of item;
determining a value of each entry included in the invoice;
identifying for each entry an approver with authority to approve the entry based on the associated item type;
automatically approving one or more entries included in the invoice based on the determined value of each approved entry; and
making one or more entries available to a corresponding approver based on the available one or more entries' determined value, wherein each entry that is made available excludes entries that the corresponding authorized approver does not have the authority to approve.

43. The computer-readable medium of 42, wherein the method further comprises:
receiving an indication from each corresponding approver reflecting a decision on whether to approve each entry that the corresponding approver has the authority to approve.

44. The computer-readable medium of claim 42, wherein automatically approving one or more entries included in the invoice based on the approved entries' determined value includes:
automatically approving each entry included in the invoice that has a determined value below a predetermined value.

45. The computer-readable medium of claim 42, wherein making one or more entries available to a corresponding approver based on the available one or more entries' determined value includes:
making each entry that has a determined value above a predetermined value available to a corresponding authorized approver.

46. A computer-readable medium including instructions for performing a method, when executed by a processor, for facilitating business transactions between a providing entity and a purchasing entity, comprising:
providing, by the providing entity, an invoice including a plurality of items;
determining, for each item included in the invoice, a corresponding approver with authority to approve the item; and
facilitating a review process for each item based on the determination, wherein the review process is defined by the purchasing entity.

47. The computer-readable medium of claim 46, wherein the review process includes:
making information on each item available to the corresponding approver, wherein each item that is made available excludes items that the corresponding approver does not have the authority to approve; and
receiving an indication from each corresponding approver reflecting a decision on whether to approve items that have been made available to the corresponding determined approver.

48. The computer-readable medium of claim 46, wherein the review process includes:
automatically approving each item included in the invoice based on a value of the invoice.

49. The computer-readable medium of claim 46, wherein the review process includes:
automatically approving each item included in the invoice based on a value of the item.

50. The computer-readable medium of claim 46, wherein the review process includes:
receiving an indication of a delegated approver with authority to approve one or more items included in the invoice; and
making the one or more items available to the delegated approver, wherein the one or more items that are made available excludes items that the delegated approver does not have the authority to approve.

51. A computer-readable medium including instructions for performing a method, when executed by a processor, for facilitating business transactions, the method comprising:
receiving information reflecting an invoice with a plurality of items; and
directing individual items to respective approvers such that each respective approver receives only items that the respective approver is authorized to review.

52. A computer-readable medium including instructions for performing a method, when executed by a processor, for facilitating business transactions, comprising:
requesting access to invoice information associated with an invoice including a plurality of items;
accessing the invoice information that includes information on only items included in the invoice that are authorized for review; and
generating an indication reflecting a decision one whether to approve each authorized item.

53. The computer-readable medium of claim 52, wherein the invoice information is reflected in an in-box, and requesting access to the invoice information includes:
requesting access to the in-box in response to an indication of the availability of the invoice information reflected in the in-box.

54. The computer-readable medium of claim 52, wherein the invoice information is reflected in an in-box, and wherein accessing the invoice information includes:
accessing the in-box.

55. The computer-readable medium of claim 52, wherein the invoice information is reflected in an in-box, and generating an indication includes:
generating the indication by receiving selections on whether to approve each authorized item reflected in the in-box.

56. A computer-readable medium including instructions for performing a method, when executed by a processor, for facilitating electronic business transactions, comprising:
receiving profile information associated with a user;
receiving an indication reflecting the assignment of the user's approver status based on the profile information;
assigning an entity identifier to the user based on the approver status, wherein the identifier indicates an entity within a providing entity that purchases items from a purchasing entity; and
assigning the user as an approver with the authority to approve the purchases reflected in entries included in an invoice provided by the providing entity.

57. A computer-readable medium including instructions for performing a method, when executed by a processor, for facilitating electronic business transactions in a system including a purchasing entity that includes one or more sub-entities, and a providing entity, the method comprising:
receiving a notification that an invoice including one or more line items has been provided by the providing entity;
requesting access to information associated with the invoice;
receiving line item information associated with selected line items of the one or more line items included in the invoice;
performing a dispute/approval process on the line item information; and
generating an indication reflecting results of the dispute/approval process.

58. The computer-readable medium of claim 57, wherein an approver is associated with each sub-entity of the purchasing entity, and the notification is directed to approvers who are associated with sub-entities that are indicated in line items included in the invoice, and wherein requesting access to information includes:
generating, by each approver that has received a notification, a request to access information associated with the invoice.

59. The computer-readable medium of claim 58, wherein receiving line item information associated with selected line items of the one or more line items includes:
providing line item information to respective approvers based on the authority of the respective approvers to approve the selected line items included in the invoice, wherein each respective approver is not presented with line item information associated with line items the respective approver is not authorized to approve.

60. The computer-readable medium of claim 57, wherein performing a dispute/approval process on the line item information includes:
receiving an indication reflecting a dispute or approval of each selected line item.

61. The computer-readable medium of claim 57, wherein performing a dispute/approval process on the line item information includes:
receiving an indication reflecting a dispute of a set of the selected line items; and
receiving a second indication reflecting an approval of a second set of the selected line items.

62. A system for facilitating electronic business transactions, comprising:
means for providing an invoice including a plurality of entries, each entry associated with a type of item;
means for determining, for each entry, an individual with authority to approve the entry based on the associated item type;
means for making each entry available to the determined individual; and
means for receiving, for each entry, an indication from the determined individual reflecting a decision on whether to approve the entry,
wherein entries that the individual does not have authority to approve are not made available to the individual.

63. The system of claim 62, wherein each associated item type identifies a respective purchasing entity, and wherein the means for determining an individual with authority to approve the entry based on the associated item type includes:
means for determining an association between an individual and a respective purchasing entity identified by the entry type; and
means for determining an individual with authority to approve the entry based on the determined association.

64. The system of claim 62, further comprising:
means for determining, for each entry, a second individual with authority to approve the decision reflected by the received indication;
means for making each entry and indication available to the second individual; and
means for receiving a second indication from the second individual reflecting a second decision concerning the entry.

65. The system of claim 62, wherein a second individual is authorized to approve each entry included in the invoice, and wherein the system further comprises:
means for making each entry included in the invoice available to a second individual for further approval after receipt of an indication reflecting an approval or dispute or the entry.

66. A system for facilitating electronic business transactions, comprising:
means for providing an invoice including a plurality of entries;
means for determining a value of the invoice; and
means for automatically approving all of the entries included in the invoice based on the determined value.

67. A system for facilitating electronic business transactions, comprising:
means for providing an invoice including a plurality of entries, each entry associated with a type of item;
means for determining a value of each entry included in the invoice;
means for identifying for each entry an approver with authority to approve the entry based on the associated item type;
means for automatically approving one or more entries included in the invoice based on the determined value of each approved entry; and
means for making one or more entries available to a corresponding approver based on the available one or more entries' determined value, wherein each entry that is made available excludes entries that the corresponding authorized approver does not have the authority to approve.

68. The system of 67, further comprising:
means for receiving an indication from each corresponding approver reflecting a decision on whether to approve each entry that the corresponding approver has the authority to approve.

69. The system of claim 68, wherein the means for automatically approving one or more entries included in the invoice based on the approved entries' determined value includes:
means for automatically approving each entry included in the invoice that has a determined value below a predetermined value.

70. The system of claim 67, wherein the means for making one or more entries available to a corresponding approver based on the available one or more entries' determined value includes:
means for making each entry that has a determined value above a predetermined value available to a corresponding authorized approver.

71. A system for facilitating business transactions between a providing entity and a purchasing entity, comprising:
means for providing, by the providing entity, an invoice including a plurality of items;
means for determining, for each item included in the invoice, a corresponding approver with authority to approve the item; and
means for facilitating a review process for each item based on the determination, wherein the review process is defined by the purchasing entity.

72. The system of claim 71, wherein the means for facilitating a review process includes:
means for making information on each item available to the corresponding approver, wherein each item that is made available excludes items that the corresponding approver does not have the authority to approve; and
means for receiving an indication from each corresponding approver reflecting a decision on whether to approve items that have been made available to the corresponding determined approver.

73. The system of claim 71, wherein the means for facilitating a review process includes:
means for automatically approving each item included in the invoice based on a value of the invoice.

74. The system of claim 71, wherein the means for facilitating a review process includes:
means for automatically approving each item included in the invoice based on a value of the item.

75. The system of claim 71, wherein the means for facilitating a review process includes:
means for receiving an indication of a delegated approver with authority to approve one or more items included in the invoice; and
means for making the one or more items available to the delegated approver, wherein the one or more items that are made available excludes items that the delegated approver does not have the authority to approve.

76. A system for facilitating business transactions, comprising:
means for receiving information reflecting an invoice with a plurality of items; and
means for directing individual items to respective approvers such that each respective approver receives only items that the respective approver is authorized to review.

77. A system for facilitating business transactions, comprising:
means for requesting access to invoice information associated with an invoice including a plurality of items;
means for accessing the invoice information that includes information on only items included in the invoice that are authorized for review; and
means for generating an indication reflecting a decision one whether to approve each authorized item.

78. The system of claim 77, wherein the invoice information is reflected in an in-box, and the means for requesting access to the invoice information includes:
means for requesting access to the in-box in response to an indication of the availability of the invoice information reflected in the in-box.

79. The system of claim 77, wherein the invoice information is reflected in an in-box, and wherein the means for accessing the invoice information includes:
means for accessing the in-box.

80. The system of claim 77, wherein the invoice information is reflected in an in-box, and the means for generating an indication includes:
means for generating the indication by receiving selections on whether to approve each authorized item reflected in the in-box.

81. A system for facilitating electronic business transactions, comprising:
means for receiving profile information associated with a user;
means for receiving an indication reflecting the assignment of the user's approver status based on the profile information;
means for assigning an entity identifier to the user based on the approver status, wherein the identifier indicates an entity within a providing entity that purchases items from a purchasing entity; and
means for assigning the user as an approver with the authority to approve the purchases reflected in entries included in an invoice provided by the providing entity.

82. A system for facilitating electronic business transactions in a system including a purchasing entity that includes one or more sub-entities, and a providing entity, the system comprising:
means for receiving a notification that an invoice including one or more line items has been provided by the providing entity;
means for requesting access to information associated with the invoice;
means for receiving line item information associated with selected line items of the one or more line items included in the invoice;
means for performing a dispute/approval process on the line item information; and
means for generating an indication reflecting results of the dispute/approval process.

83. The means for of claim 82, wherein an approver is associated with each sub-entity of the purchasing entity, and the notification is directed to approvers who are associated with sub-entities that are indicated in line items included in the invoice, and wherein the means for requesting access to information includes:
means for generating, by each approver that has received a notification, a request to access information associated with the invoice.

84. The system of claim 83, wherein the means for receiving line item information associated with selected line items of the one or more line items includes:
means for providing line item information to respective approvers based on the authority of the respective approvers to approve the selected line items included in the invoice, wherein each respective approver is not presented with line item information associated with line items the respective approver is not authorized to approve.

85. The system of claim 82, wherein the means for performing a dispute/approval process on the line item information includes:
means for receiving an indication reflecting a dispute or approval of each selected line item.

86. The system of claim 82, wherein the means for performing a dispute/approval process on the line item information includes:
means for receiving an indication reflecting a dispute of a set of the selected line items; and
means for receiving a second indication reflecting an approval of a second set of the selected line items.
